(19) United States
(12) Patent Application Publication
(10) Pub. No.: US 2014/0004240 A1
(43) Pub. Date: Jan. 2, 2014

(54) BEVERAGE CARBONATING SYSTEM AND METHOD FOR CARBONATING A BEVERAGE

(71) Applicant: Darren Hatherell, Toronto (CA)

(72) Inventor: Darren Hatherell, Toronto (CA)

(21) Appl. No.: 13/537,476

(22) Filed: Jun. 29, 2012

(51) Int. Cl. A23L 2/54

(52) U.S. Cl. CPC A23L 2/54
USPC 426/477; 261/34.1; 99/323.2

(57) ABSTRACT

A beverage carbonation system, container, carbonator and method for carbonating a beverage are provided. The beverage carbonation system has a container that is removably engageable with a carbonator. The container has a first container outlet valve and a container inlet valve that are fluidly engageable with a first carbonator outlet port and carbonator inlet port, respectively. At least one pump transfers liquid and carbon dioxide gas between a container chamber and a carbonation chamber when the container is engaged with the carbonator, thereby carbonating the liquid. When the container is disengaged from the carbonator, the first container outlet valve and the container inlet valve are closed to fluidly seal the container containing the carbonated liquid.

### FIELD

The described embodiments relate to a beverage carbonation system, container and carbonator, and a method for carbonating a beverage.

### BACKGROUND

Carbonated beverages such as, for example, sodas and sparkling water are popular with consumers. Many carbonated beverages are prepared at a factory and shipped to stores, where consumers travel to purchase them. Each of the preparation, shipping and travel may contribute to a higher cost per beverage for the consumer. Accordingly, it may be desirable to have a beverage carbonation system usable by a consumer in his/her home, for example. This may also be more convenient for a consumer.

Beverage carbonation systems are known in the art. See, for example, United States Patent Application No. 2011/0226343 to Novak et al. and U.S. Pat. No. 5,260,081 to Stumphauzer et al.

When exposed to the atmosphere, a carbonated beverage will eventually lose its “freshness” or “go flat”. It is desirable to provide beverage carbonation system that may be used in the home and allows a user to prepare a carbonated beverage for immediate or later consumption, while still maintaining a sufficient level of carbonation or “freshness” for the later consumption.

### SUMMARY

In a first aspect, some embodiments of the invention provide a beverage carbonation system. The beverage carbonation system comprises a container and a carbonator removably engageable with the container. The container comprises a shell defining a container chamber for holding a liquid. The container also comprises a first container outlet valve in the shell having a closed position and an open position and a second container inlet valve in the shell having a closed position and an open position. The carbonator comprises a first carbonator outlet port fluidly engageable with the first container outlet valve when the first container outlet valve is in the open position. The first carbonator outlet port is fluidly connected to a carbonation chamber containing a carbon dioxide source that produces a carbon dioxide gas. The carbonator also comprises a carbonator inlet port fluidly engageable with the container inlet valve when the container inlet valve is in the open position. The carbonator inlet port is fluidly connected to the carbonation chamber. The carbonator further comprises at least one pump in fluid communication with the container chamber and the carbonation chamber to transfer the liquid between the container chamber and the carbonation chamber and transfer the carbon dioxide gas between the carbonation chamber and the container chamber when the container is engaged with the carbonator, thereby carbonating the liquid. When the container is disengaged from the carbonator, the first container outlet valve and the container inlet valve are closed to fluidly seal the container containing the carbonated liquid.

In some embodiments, the container further comprises a mouth defined by the shell for receiving the liquid into the container chamber. The container may comprise a closure for sealing the mouth.

In some embodiments, an elevated pressure occurs in the container chamber when the carbonated liquid is formed therein, and the elevated pressure is substantially maintained during disengagement of the container and the carbonator.

The carbon dioxide source may be a solid material that is chemically reactive with the liquid to emit the carbon dioxide gas when the liquid contacts the carbon dioxide source. In some cases, the solid material is a mixture of sodium bicarbonate and citric acid, and the liquid is water.

In some embodiments, the beverage carbonation system further comprises a waste reservoir located in the carbonator outside the carbonation chamber and at least partially removable from a remaining portion of the carbonator. A waste valve may be in a wall of the carbonation chamber that is openable to release a waste product from the carbonation chamber into the waste reservoir.

In some embodiments, the beverage carbonation system further comprises a carbonation tube fluidly connected to the first container outlet valve and extending inwardly into the container chamber. The carbonation tube may be configured to receive carbon dioxide gas from the container chamber for recirculation between the first container outlet valve and the container inlet valve.

The beverage carbonation system may comprise a carbon dioxide cartridge for containing the carbon dioxide source. The beverage carbonation system may also comprise a transfer mechanism for transferring the carbon dioxide source from the carbon dioxide cartridge to the carbonation chamber.

In some embodiments, the carbonation chamber is integrally formed in the carbonator. The transfer mechanism may comprise at least one cutter configured to cut away at least a portion of the carbon dioxide cartridge to release the carbon dioxide source from the carbon dioxide cartridge into the carbonation chamber.

In some embodiments, the beverage carbonation system comprises a second container outlet valve in the shell having a closed position and an open position. The beverage carbonation system may also comprise a second carbonator outlet port fluidly engageable with the second container outlet valve when the second container outlet valve is in the open position. The second carbonator outlet port may be fluidly connected to a flavor chamber containing a flavor source that produces a flavored liquid. The carbonator inlet port may be fluidly connected to the flavor chamber. The at least one pump may be in fluid communication with the container chamber and the flavor chamber to circulate the liquid between the container chamber and the flavor chamber when the container is engaged with the carbonator, thereby flavoring the liquid. When the container is disengaged from the carbonator, the second container outlet valve may be closed to fluidly seal the container containing the flavored liquid.

In some embodiments, the beverage carbonation system comprises a flavor cartridge for containing the flavor source. The beverage carbonation system may also comprise a transfer mechanism for transferring the flavor source from the flavor cartridge to the flavor chamber.

The beverage carbonation system may comprise a combination cartridge having a carbon dioxide portion for containing the carbon dioxide source and a flavor portion for containing the flavor source. Some embodiments of the beverage carbonation system comprise at least one transfer mechanism for transferring the flavor source from the flavor portion to the flavor chamber and the carbon dioxide source from the carbon dioxide portion to the carbonation chamber. The carbon dioxide portion and the flavor portion may be coupled to one another.

In some embodiments, the beverage carbonation system comprises a filter chamber in the carbonator and containing a removable filter in fluid communication with the container chamber to filter the liquid.

According to a second aspect, some embodiments of the invention provide a container for making a carbonated beverage. The container is removably engageable with a carbonator having a first carbonator outlet port fluidly connected to a carbonation chamber containing a carbon dioxide source and having a carbonator inlet port fluidly connected to the carbonation chamber. The container comprises a shell defining a container chamber for holding a liquid. The container comprises a first container outlet valve in the shell having a closed position and an open position and a container inlet valve in the shell having a closed position and an open position. The first container outlet valve is fluidly engageable with the first carbonator outlet port when the first container outlet valve is in the open position. The container inlet valve is fluidly engageable with the carbonator inlet port when the container inlet valve is in the open position. The container chamber is fluidly engageable with at least one pump in fluid communication with the carbonation chamber to transfer the liquid between the container and the carbonation chamber and transfer the carbon dioxide gas between the carbonation chamber and the container chamber when the container is engaged with the carbonator, thereby carbonating the liquid. When the container is disengaged from the carbonator, the first container outlet valve and the container inlet valve are closed to fluidly seal the container containing the carbonated liquid.

Some embodiments of the invention provide a container comprising a second container outlet valve in the shell having a closed position and an open position. The second container outlet valve may be fluidly engageable with a second carbonator outlet port of the carbonator when the second container outlet valve is in the open position. The second carbonator outlet port may be in fluid communication with a flavor chamber of the carbonator. The carbonator inlet port may be in fluid communication with the flavor chamber. The container chamber may be fluidly engageable with the at least one pump in fluid communication with the flavor chamber to circulate the liquid between the container chamber and the flavor chamber when the container is engaged with the carbonator, thereby flavoring the liquid. When the container is disengaged from the carbonator, the second container outlet valve is closed to fluidly seal the container containing the flavored liquid.

According to a third aspect, some embodiments of the invention provide a carbonator for making a carbonated beverage. The carbonator is removably engageable with a container having a first container outlet valve having a closed position and an open position and a container inlet valve having a closed position and an open position. The carbonator comprises a first carbonator outlet port fluidly engageable with the first container outlet valve when the first container outlet valve is in the open position. The first carbonator outlet port is fluidly connected to a carbonation chamber containing a carbon dioxide gas. The carbonator comprises a carbonator inlet port fluidly engageable with the container inlet valve when the container inlet valve is in the open position. The carbonator inlet port is fluidly connected to the carbonation chamber. The carbonator comprises at least one pump in fluid communication with the carbonation chamber and fluidly engageable with the container chamber to transfer the liquid between the container chamber and the carbonation chamber and transfer the carbon dioxide gas between the carbonation chamber and the container chamber when the carbonator is engaged with the container, thereby carbonating the liquid. When the container is disengaged from the carbonator, the first container outlet valve and the container inlet valve are closed to fluidly seal the container containing the carbonated liquid.

In some embodiments, the carbonator comprises a flavor chamber containing a flavor source that produces a flavored liquid. The flavor chamber may comprise a second carbonator outlet port fluidly engageable with a second container outlet valve in the container when the second container outlet valve is in the open position. The second carbonator outlet port may be fluidly connected to the flavor chamber. The carbonator may be fluidly connected to the flavor chamber. The at least one pump may be in fluid communication with the flavor chamber to circulate the liquid between the container chamber and the flavor chamber when the container is engaged with the carbonator, thereby flavoring the liquid. When the container is disengaged from the carbonator, the second container outlet valve is closed to fluidly seal the container containing the flavored liquid.

According to a fourth aspect, some embodiments of the invention provide a method of making a carbonated beverage. The method comprises introducing a liquid into a container and sealing the container with a closure. The method comprises engaging the container with a carbonator and placing a carbon dioxide source in a carbonation chamber of the carbonator. The method also comprises opening a first container outlet valve in the container to transfer a portion of the liquid to the carbonation chamber to react with the carbon dioxide source in the carbonation chamber to produce a carbon dioxide gas. The method further comprises opening a container inlet valve in the container to transfer the carbon dioxide gas produced by the carbon dioxide source into the container to obtain a carbonated liquid in the container. Furthermore, the method comprises closing the first container outlet valve and the container inlet valve to seal the container and disengaging the container from the carbonator.

In some embodiments, the method comprises the following steps prior to closing the first container outlet valve and the container inlet valve to seal the container and disengaging the container from the carbonator. These steps include placing a flavor source in a flavor chamber of the carbonator. These steps also include opening a second container outlet valve in the container to transfer a portion of the liquid to the flavor chamber to mix the liquid with the flavor source to produce a flavored liquid in the flavor chamber. These steps further include opening the container inlet valve in the container to transfer the flavored liquid produced by the flavor source into the container to obtain the flavored liquid in the container.

### BRIEF DESCRIPTION OF THE DRAWINGS

A preferred embodiment of the present invention will now be described in detail with reference to the drawings, in which:

FIG. 1 is an exploded perspective view of an exemplary beverage carbonation system;

FIG. 2 is a perspective view of an exemplary first carbonator outlet valve of the beverage carbonation system of FIG. 1, in the closed position;

FIG. 3 is a perspective view of the first carbonator outlet valve of FIG. 2, in the open position;

FIG. 4 is a perspective view of the beverage carbonation system of FIG. 1 wherein the container and carbonator are engaged;

FIG. 5 is a cut-away perspective view of the beverage carbonation system of FIG. 4;

FIG. 6 is a cut-away perspective view of an exemplary container;

FIG. 7 is a cut-away perspective view of an exemplary carbonator;

FIG. 8 is a perspective view of an exemplary carbon dioxide cartridge and transfer mechanism, wherein the carbon dioxide cartridge is sealed;

FIG. 9 is a perspective view of the carbon dioxide and transfer mechanism of FIG. 8, wherein the carbon dioxide cartridge is open;

FIG. 10 is a perspective view of the carbon dioxide cartridge of FIG. 8 and another exemplary transfer mechanism, wherein the carbon dioxide cartridge is sealed;

FIG. 11 is a perspective view of the carbon dioxide caretridge and transfer mechanism of FIG. 10, wherein the carbon dioxide cartridge is open;

FIG. 12 is a cut-away perspective view of another exemplary beverage carbonation system;

FIG. 13 is a cut-away perspective view of yet another exemplary beverage carbonation system;

FIG. 14 is a perspective view of an exemplary flavor cartridge;

FIG. 15 is a perspective view of an exemplary combination cartridge having a carbon dioxide portion and a flavor portion;

FIG. 16 is a cut-away perspective view of another exemplary container;

FIG. 17 is a cut-away perspective view of another exemplary carbonator;

FIG. 18 is a cut-away perspective view of a further exemplary beverage carbonation system; and

FIG. 19 is a cut-away perspective view of yet a further exemplary beverage carbonation system.

### DESCRIPTION OF EXEMPLARY EMBODIMENTS

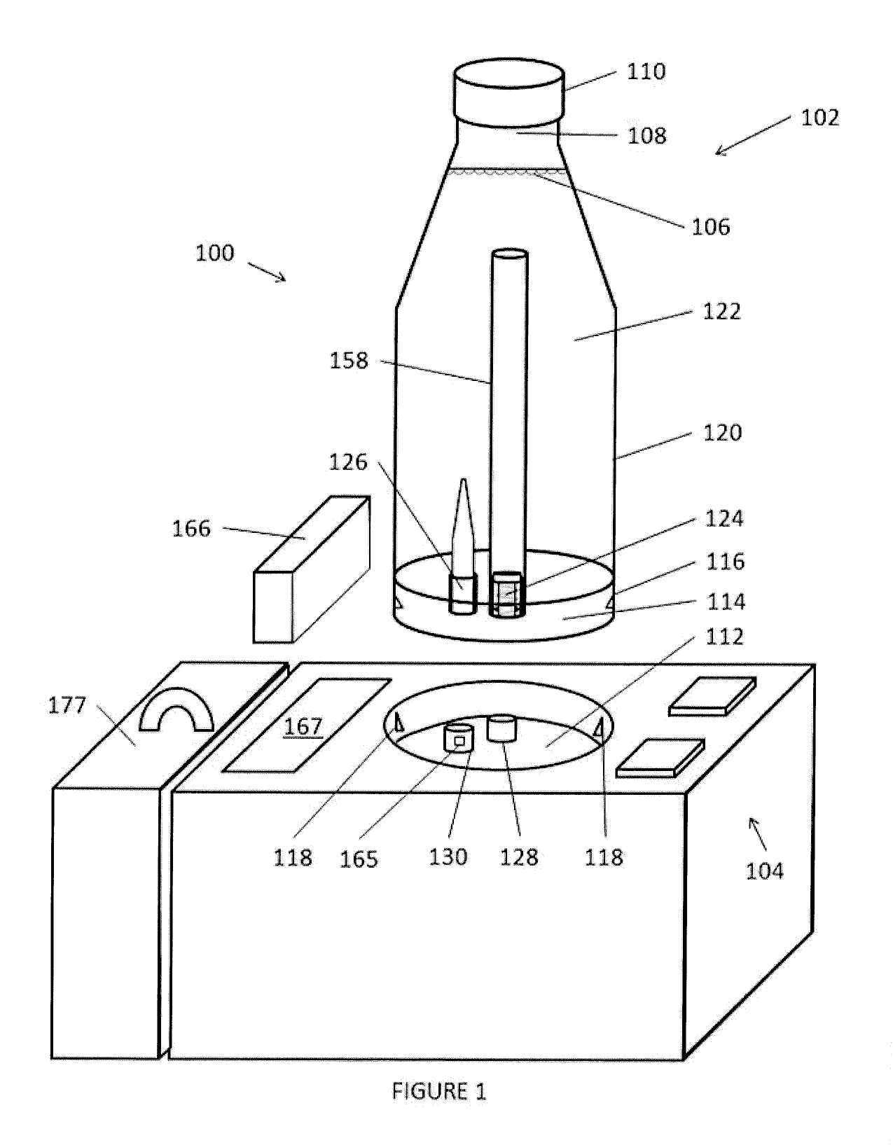

Reference is first made to FIG. 1, which shows an example embodiment of a beverage carbonation system 100. In the example shown, beverage carbonation system 100 comprises a container 102 and a carbonator 104. Carbonator 104 is removably engageable with container 102.

Continuing to refer to FIG. 1, a user of beverage carbonation system 100 may fill container 102 with a liquid 106, such as, but not limited to, water, juice, coffee and alcohol. In some cases, container 102 has a mouth 108 and a closure 110 for sealing mouth 108. After the user fills container 102 with liquid 106, the user may seal mouth 108 with closure 110. When container 102 is filled with liquid 106 and engaged with carbonator 104, carbonator 104 can draw a quantity of liquid 106 from container 102 for mixing with a reactive carbon dioxide source in the carbonator 104 to produce gaseous carbon dioxide. The gaseous carbon dioxide is introduced into container 102 to mix with the liquid therein to form a carbonated liquid in container 102. In addition, the carbonator may circulate the liquid through a flavor chamber containing a flavor source (e.g. flavor crystals, coffee grinds, or syrup) to obtain a flavored liquid. The user is able to disengage the container 102 from carbonator 104 to obtain a sealed carbonated beverage that may be opened for immediate consumption or stored for later use. The sealed carbonated beverage may share some characteristics with a store bought carbonated beverage, because sealed container 102 limits exposure to ambient pressure and reduces carbonation losses.

Continuing to refer to FIG. 1, carbonator 104 may comprise a cavity 112 for receiving at least a portion of container 102. In the example shown, carbonator 104 comprises a cavity 112 sized to receive a base 114 of container 102. Optionally, cavity 112 and base 114 have corresponding circular shapes. In some embodiments, one or more of base 114 and cavity 112 comprise retentive elements for securing container 102 to carbonator 104. The retentive elements may comprise, for example, mating magnetic elements, mating threads, a friction grip or a detent mechanism. In the example shown in FIG. 1, base 114 has recesses 116 for receiving latches 118 of cavity 112. In an alternative embodiment, the recesses are located in cavity 112, and the latches are located in base 114 (not shown).

The retentive elements (ex. recesses 116 and latches 118) may engage automatically upon the insertion of container 102 into cavity 112. Each latch 118 may be biased inwardly (by a spring, for example) toward a corresponding recess 116. Alternatively, the retentive elements may be actuated in response to an additional action by the user. For example, the movement of a button may cause latches 118 to insert into recesses 116. In other embodiments, the retentive elements may be electronically actuated. For example, a controller may power mating electromagnets upon the start of the carbonation process. Or alternatively, the retentive elements may be engaged by the user with a manual lever, latch or lock (not shown).

The retentive elements may be releasable automatically upon disengagement of container 102 and carbonator 104. For example, the action of pulling container 102 apart from carbonator 104 may provide enough outward force to overcome the inward bias of a springed latches 118. Alternatively, latches 118 may recede from recesses 116 by the movement of a button. In another example, a controller disconnects mating electromagnets from a power source to disengage latches 118 and recesses 116. Or alternatively, the retentive elements may be disengaged by the user with a manual lever, latch or lock (not shown).

Continuing to refer to FIG. 1, container 102 comprises a shell 120 defining a container chamber 122 for holding liquid 106. Shell 120 may be made of glass or plastic, for example. As illustrated, base 114 is a part of shell 120. Container 102 may be a bottle. Container 102 may also have a mouth 108 defined by shell 120 for introducing the liquid into container chamber 122. Optionally, mouth 108 is located at the top of container 102 and provides an upwardly facing opening when container 102 stands upright. Optionally, at least a portion of shell 120 tapers inwardly towards mouth 108, to facilitate liquid consumption directly from mouth 108, if desired.

Container 102 may also comprise a closure 110 for sealing mouth 108. Closure 110 may be configured to operatively open and seal mouth 108. To open mouth 108, closure 110 may be removed entirely from mouth 108. As shown, closure 110 may be a lid that is removably engageable with mouth 108. Closure 110 and mouth 108 may have mating threads that permit a user to twist closure 110 onto and off of container 102. Optionally, closure 110 is made of rubber material or has a rubber gasket therein to create a seal with mouth 108. Alternatively, closure 110 may be manipulated to have an opening therethrough (ex. by having a sliding or hinged door built into the closure, which are not shown). When the closure 110 operatively opens mouth 108, the user can pour a liquid into or out of mouth 108. When closure 110 operatively seals mouth 108, mouth 108 is sealed in a substantially gas-tight and liquid-tight manner. Although closure 110 is illustrated as a threaded lid, other non-limiting examples for closure 110 include a removable adhesive film, a resilient plug or a cork.

Continuing to refer to FIG. 1, container 102 has first container outlet valve 124 in shell 120. Optionally, first container outlet valve 124 is located in base 114. First container outlet valve 124 has a closed position and an open position. When first container outlet valve 124 is in the open position, it provides an open passageway for fluid to travel between container chamber 122 and the external atmosphere. When first container outlet valve 124 is in the closed position, fluid is blocked from exiting container chamber 122 via first container outlet valve 124.

Container 102 also has container inlet valve 126 in shell 120. Optionally, container inlet valve 126 is located in base 114. Container inlet valve 126 has a closed position and an open position. When container inlet valve 126 is open, it provides an open passageway for fluid to travel between container chamber 122 and the external atmosphere. When container inlet valve 126 is closed, fluid is blocked from exiting container chamber 122 via container inlet valve 126.

When container 102 is engaged with carbonator 104, first container outlet valve 124 and container inlet valve 126 may be opened to allow fluid to pass between container 102 and carbonator 104. When container 102 is disengaged from carbonator 104, first container outlet valve 124 and container inlet valve 126 are closed to fluidly seal container 102 containing carbonated liquid (not shown in FIG. 1).

First container outlet valve 124 and container inlet valve 126 may be configured (e.g. biased by a spring or otherwise) to seal automatically on or prior to the release of container 102 from carbonator 104. For example, first container outlet valve 124 and container inlet valve 126 may be, as non-limiting examples, a mechanical spring valve or a check valve. First container outlet valve 124 and container inlet valve 126 may be one-way valves. When open, first container outlet valve 124 may only allow fluid to flow out of container chamber 122. When open, container inlet valve 126 may only allow fluid to flow into container chamber 122. More specifically, first container outlet valve 124 and container inlet valve 126 may be a ball check valve, a stop check valve, a lift check valve, or a duckbill valve.

As shown in FIG. 1, carbonator 104 has a first carbonator outlet port 128. First carbonator outlet port 128 is fluidly engageable with first container outlet valve 124 when first container outlet valve 124 is in the open position. When first carbonator outlet port 128 is fluidly engaged with first container outlet valve 124, the first carbonator outlet port and the first container outlet valve are, directly or indirectly, fluidly coupled to one another. When the first container outlet valve 124 is open and fluidly engages first carbonator outlet port 128, fluid is able to flow through first container outlet valve 124 and first carbonator outlet port 128. In this manner, fluid passes between container chamber 122 and carbonator 104.

Carbonator 104 also has a carbonator inlet port 130. Carbonator inlet port 130 is fluidly engageable with container inlet valve 126 when container inlet valve 126 is in the open position. When carbonator inlet port 130 is fluidly engaged with container inlet valve 126, the carbonator inlet port 130 and container inlet valve 126 are, directly or indirectly, fluidly coupled to one another. When the container inlet valve 126 is open and fluidly engages carbonator inlet port 130, fluid is able to flow through container inlet valve 126 and carbonator inlet port 130. In this manner, fluid passes between carbonator 104 and container chamber 122.

Optionally, first carbonator outlet port 128 and carbonator inlet port 130 are located in cavity 112 of carbonator 104.

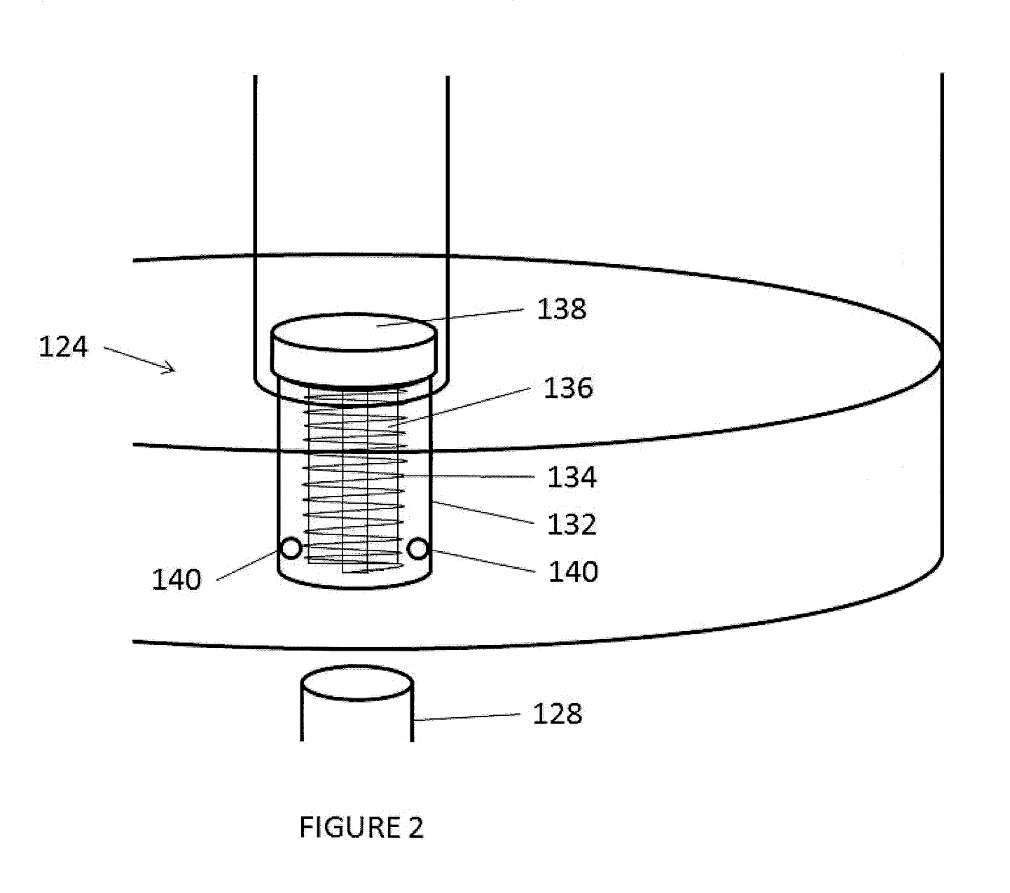

FIG. 2 shows an example first container outlet valve 124, in the form of a mechanical spring valve. In the example shown, first container outlet valve 124 comprises a housing 132, spring 134, shaft 136, cap 138 and seals 140. First carbonator outlet port 128 of carbonator 104 (see FIG. 1) is receivable by housing 132, which has a hollow cylindrical shape. Seals 140 are located between shaft 136 and housing 132. Spring 134 is coupled to the top of housing 132 and the bottom of shaft 136 to bias cap 138 toward a closed position against the top of housing 132. FIG. 2 shows first container outlet valve 124 in the closed position.

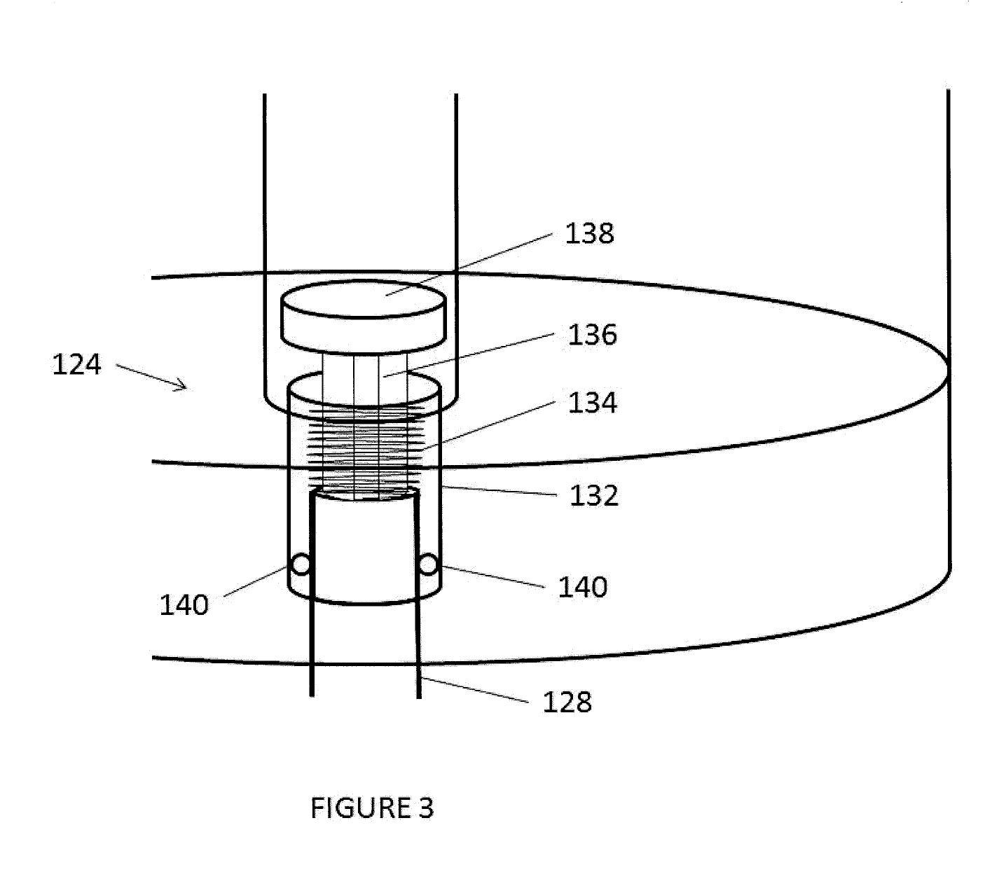

As shown in FIG. 3, when first carbonator outlet port 128 is received by housing 132, it displaces shaft 136 such that seals 140 become wedged between first carbonator port 128 and housing 132. In this manner, a fluid tight seal may be provided by seals 140. When first carbonator outlet port 128 is received inside housing 132, it pushes shaft 136 out of housing 132, moving cap 138 away from the top of housing 132. When shaft 136 is pushed by first carbonator outlet port 128, spring 134 compresses to accommodate the movement of shaft 136. The gap created between cap 138 and the top of housing 132 provides an open passage (i.e. the valve is open). When open, first container outlet valve 124 permits fluid to pass from container chamber 122 into carbonator 104 (see FIG. 1) via first carbonator outlet port 128. Conversely, when first carbonator outlet port 128 is withdrawn from housing 132, cap 138 seats onto and seals the top of housing 132 under the bias of spring 134, thereby closing first container outlet valve 124.

Typically, container inlet valve 126 is a one-way valve that, when open, allows fluid to flow into container chamber 122, but not out of container chamber 122. More specifically, container inlet valve 126 may be a check valve that is biased closed (by a spring, for example) and configured to open when the net fluid pressure across the valve rises above a threshold value. Alternatively, container inlet valve 126 may be a mechanical spring valve that operates in similar manner to the first container outlet valve 124 shown in FIGS. 2 and 3.

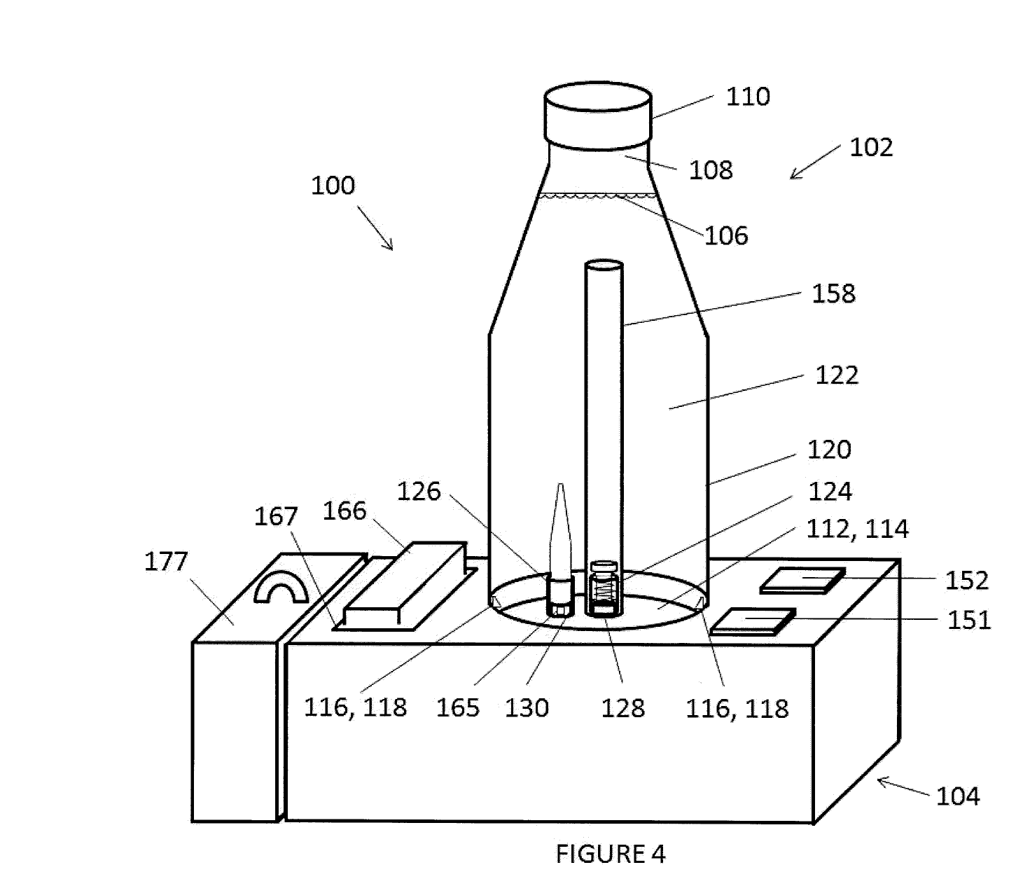

FIG. 4 shows container 102 engaged with carbonator 104. Container 102 may be received in a cavity 112. When container 102 engages carbonator 104, this fluidly engages first container outlet valve 124 with first carbonator outlet port 128 and container inlet valve 126 with carbonator inlet port 130.

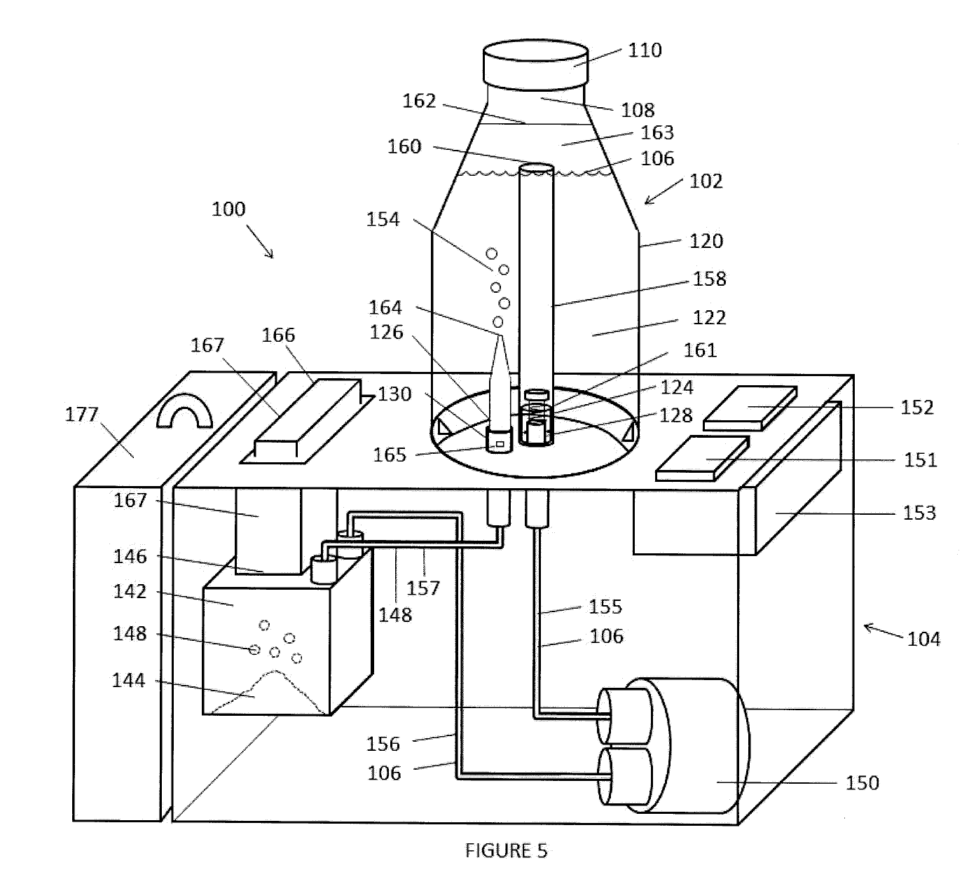

Referring now to FIG. 5, carbonator 104 may have a start actuator 151 and stop actuator 152, which are optionally in the form of depressible buttons connected to a controller 153. Activation of start actuator 151 or stop actuator 152 sends a corresponding signal to controller 153 to perform the desired operation. Controller 153 may comprise any logic board suitably configured to control the operation of carbonator 104.

Start actuator 151 may be activated after the container 102 and carbonator 104 are engaged. In some embodiments, activation of start actuator 151 opens first container outlet valve 124 and container inlet valve 126. In some embodiments, activation of start actuator 151 temporarily locks container 102 and carbonator 104 into engagement with one another. In some embodiments, activation of start actuator 151 simultaneously opens the container valves and temporarily locks container 102 to carbonator 104.

Activation of start actuator 151 will send a corresponding signal to controller 153 to activate at least pump 150.

Referring to FIGS. 1 and 5, when closure 110 removed from mouth 108, liquid 106 may be introduced into container chamber 122 through mouth 108. FIG. 1 illustrates liquid 106 inside container chamber 122. In some embodiments, a user may manually fill container chamber 122 (e.g. by pouring a liquid into mouth 108). In variant embodiments, beverage carbonation system 100 may comprise a source of liquid (not shown), which introduces liquid into container 102. For example, system 100 may comprise plumbing fluidly connected with a municipal water supply.

After liquid 106 is introduced into container chamber 122, closure 110 may be secured to mouth 108 of container 102 to seal mouth 108. Liquid 106 may be added before container 102 is engaged with carbonator 104 (as shown in FIG. 1) or after container 102 is engaged with carbonator 104 (as shown in FIG. 5).

Referring to FIG. 5, carbonator 104 has carbonation chamber 142. Optionally, carbonation chamber 142 is integrally formed in carbonator 104. Carbonation chamber 142 contains a carbon dioxide source 144. Optionally, carbonation chamber 142 has an access hatch 146 for introducing carbon dioxide source 144 into carbonation chamber 142. Carbon dioxide cartridge source 144 is reactive with liquid 106 to produce carbon dioxide gas 148 when the liquid contacts carbon dioxide source 144. Optionally, carbon dioxide source 144 is a solid material that is chemically reactive with liquid 106 to emit carbon dioxide gas 148 when the liquid contacts the solid material. Examples of liquid 106 include, but are not limited to, water, juice, coffee, tea and alcohol. Carbon dioxide source 144 may be, for example, an acid mixed with a carbonate, in wet or dry form, combined or separate until required. In some cases, a solid material carbon dioxide source 144 is a mixture of sodium bicarbonate and citric acid, and liquid 106 is water. More specifically, the solid material may be a dry solid material, such as a powder. Sodium bicarbonate and citric acid are advantageous for use with water because when they react with water they do not create heat during the reaction. This is desirable for producing a cooled carbonated beverage. In some cases, dry citric acid and sodium bicarbonate have some benefits, including for example, being relatively inexpensive, non-toxic, relatively easy to handle and/or capable of pre-mixing.

As shown in FIG. 5, first carbonator outlet port 128 is fluidly connected to carbonation chamber 142 containing carbon dioxide source 144 that produces carbon dioxide gas 148. Carbonator inlet port 130 is fluidly connected to carbonation chamber 142.

When first container outlet valve 124 is open and fluidly engages first carbonator outlet port 128, liquid 106 flows from container chamber 122 into carbonation chamber 142 to interact with the carbon dioxide source 144 to form carbon dioxide gas 148 in carbonation chamber 142.

When container inlet valve 126 is open and fluidly engages carbonator inlet port 130, carbon dioxide gas 148 flows from carbonation chamber 142 to container chamber 122 to mix with liquid 106 in container chamber 122 to form a carbonated liquid 154 in container chamber 122.

Carbonator 104 comprises at least one pump 150 in fluid communication with container chamber 122 and carbonation chamber 142. At least one pump 150 transfers liquid 106 between container chamber 122 and carbonation chamber 142 when container 102 is engaged with carbonator 104. At least one pump 150 also transfers carbon dioxide gas 148 between carbonation chamber 142 and container chamber 122 when container 102 is engaged with carbonator 104, thereby carbonating liquid 106.

Optionally, carbonator 104 has one pump 150. In this case, pump 150 pumps liquid 106 from first carbonator outlet port 128 to pump 150 via line 155, then from pump 150 to carbonation chamber 142 via line 156. Pump 150 then pumps carbon dioxide gas 148 from carbonation chamber 142 to carbonator inlet port 130 via line 157. Alternatively, multiple pumps 150 may be employed (not shown).

As shown in FIG. 5, beverage carbonation system 100 may have carbonation tube 158. Carbonation tube 158 is fluidly connected to first container outlet valve 124 and extends inwardly into container chamber 122. Optionally, carbonation tube 158 is in the shape of a straw, and extends vertically upwardly into container chamber 122 from base 114. To carbonate liquid 106, a portion of liquid 106 enters a first end 160 of carbonation tube 158. Optionally, first end 160 is the top end of carbonation tube 158. Optionally, second end 161 of carbonation tube is connected to first container outlet valve 124.

In some cases, it may be desirable to limit the quantity of liquid that is drawn into carbonation chamber 142. When pump 150 is activated, a portion of liquid 106 is drawn through first end 160 of carbonation tube 158 and drawn to first container outlet valve 124. As this process continues, the level of liquid 106 inside the container chamber 122 falls. At a certain point, the liquid becomes level with first end 160 of carbonation tube 158. When the level of liquid 106 is at or below first end 160 of carbonation tube 158, no more liquid is drawn through carbonation tube 158. Accordingly, the height of carbonation tube 158 limits the amount of liquid 106 that may be drawn into the carbonation chamber 142 of carbonator 104. More specifically, the maximum volume of liquid 106 that may be drawn into the container chamber 122 may be equal to the volume of container chamber 122 situated at an elevation above first end 160 of carbonation tube 158. In some cases, it takes approximately 10 seconds to lower the level of liquid 106 to first end 160 of carbonation tube 158.

In some embodiments, shell 120 of container 102 may comprise a fill line 162. Fill line 162 may correspond to an ideal level of liquid 106. When the liquid is filled to fill line 162, there may be an ideal volume of liquid 106 located at an elevation above first end 160 of carbonation tube 158. The ideal volume of liquid 106 may correspond with the specific quantity of liquid required to mix with carbon dioxide source 144 to produce carbon dioxide gas 148 at a rate sufficient to carbonate the liquid 106 inside container chamber 122. Optionally, fill line 162 corresponds to a volume of between 5% and 20%, of the total liquid 106 volume prior to commencement of the carbonation process. As one example, the total volume of liquid 106 in container chamber 122 may be 1000 mL and the volume between fill line 162 and first end 160 may be approximately 50 mL to 200 mL of liquid prior to commencement of the carbonation process.

Carbonation tube 158 is configured to receive carbon dioxide gas 148 from container chamber 122 for recirculation between first container outlet valve 124 and container inlet valve 126. Once the level of liquid falls at or below first end 160 of carbonation tube 158, no more liquid enters the carbonation tube. However, as the process continues, some carbon dioxide gas 148 injected into container chamber 122 from carbonation chamber 142 passes through the liquid in container chamber 122 and into headspace 163. Recirculating gas from headspace 163 permits carbon dioxide gas that passed through liquid 106, but did not diffuse into the liquid, to diffuse back into liquid 106. This reduces the time required to reach a desirable level of beverage carbonation because the recycled carbon dioxide gas is forced through the liquid at a faster rate than if it were to passively dissolve from headspace 163 into liquid 106.

Optionally, pump 150 is a liquid-gas pump that can pump liquid 106 from container chamber 122, through carbonation chamber 142, and back to container chamber 122, and can also pump carbon dioxide gas along a similar flow path. Alternatively, one gas pump and one liquid pump may be used.

In some embodiments, a diffuser 164 may be fluidly connected to container inlet valve 126. In the example shown, diffuser 164 comprises a nozzle that can accelerate fluid passing through it to produce a jet. This facilitates the diffusion of carbon dioxide gas 148 into liquid 106 to carbonate liquid 106 at a faster rate. Diffuser 164 may help to send carbonated liquid 154 away from container inlet valve 126 at such a rate that liquid 106 is agitated and increases the surface area of the liquid that is in contact with the carbon dioxide. In this manner, diffuser 164 may be used to increase the rate at which sufficient carbonation of liquid 106 is achieved.

Continuing to refer to FIG. 5, once the beverage has been carbonated to the desired extent, the user may activate stop actuator 152 to shutdown pump 150. Activation of stop actuator 152 sends a corresponding signal to controller 153 to perform the desired operation. Shutting down pump 150 stops the carbonation process described above. Conversely, pump 150 may automatically shut down when a sensor 165 indicates to the controller 153 that a sufficient level of pressure has been achieved in container chamber 122 to indicate a satisfactory level of beverage carbonation. Sensor 165 may be mounted to carbonator inlet port 130. In some embodiments, pump 150 shuts down after the pressure within the system (equalized across carbonator 104 and container 102) reaches approximately 50 to 80 psi. Alternatively, pump 150 may be shutdown after a pre-programmed time period. Optionally, the liquid 106 cycles through the carbonation process for approximately 30 seconds. However, the appropriate time duration varies with the volume of liquid 106 to be carbonated. Activation of stop actuator 152 may close first container outlet valve 124 and container inlet valve 126 prior to container 102 being disengaged from carbonator 104. Activation of stop actuator 152 may unlock container 102 and carbonator 104 out of engagement with one another. For example, activation of stop actuator 152 may unlock latches 118 from recesses 116. Activation of stop actuator 152 may cause one or more of the operations outlined above to occur. Conversely, a stop actuator 152 is not required when the above outlined operations occur automatically. When these operations occur automatically, an indicator (such as a light, for example, not shown) may illuminate to let the user know that carbonation has completed and that the container 102 may be disengaged from carbonator 104. Alternatively, container 102 may be unlocked with a manual latch by the user after a timed cycle is complete.

Continuing to refer to FIG. 5, during the carbonation process, liquid 106 in container chamber 122 is at least partially replaced by a carbonated liquid 154. When carbonated liquid 154 is formed in container chamber 122, an elevated pressure occurs in container chamber 122. As discussed above, when container 102 is disengaged from carbonator 104, first container outlet valve 124 and container inlet valve 126 close to seal container chamber 122. In this manner, during disengagement of container 102 and carbonator 104, the elevated pressure is substantially maintained in the container chamber. In some cases, a pressure of approximately 50 to 80 psi is maintained in container chamber 122 following the disengagement of container 102 and carbonator 104. This is advantageous because the user can store the container (in a refrigerator or on a counter, for example) for later consumption. The closed container valves allow the container to remain sealed, to minimize carbonation losses to the external atmosphere. This prevents the carbonated beverage from going “flat” during storage, and preserves the carbonated taste for later consumption.

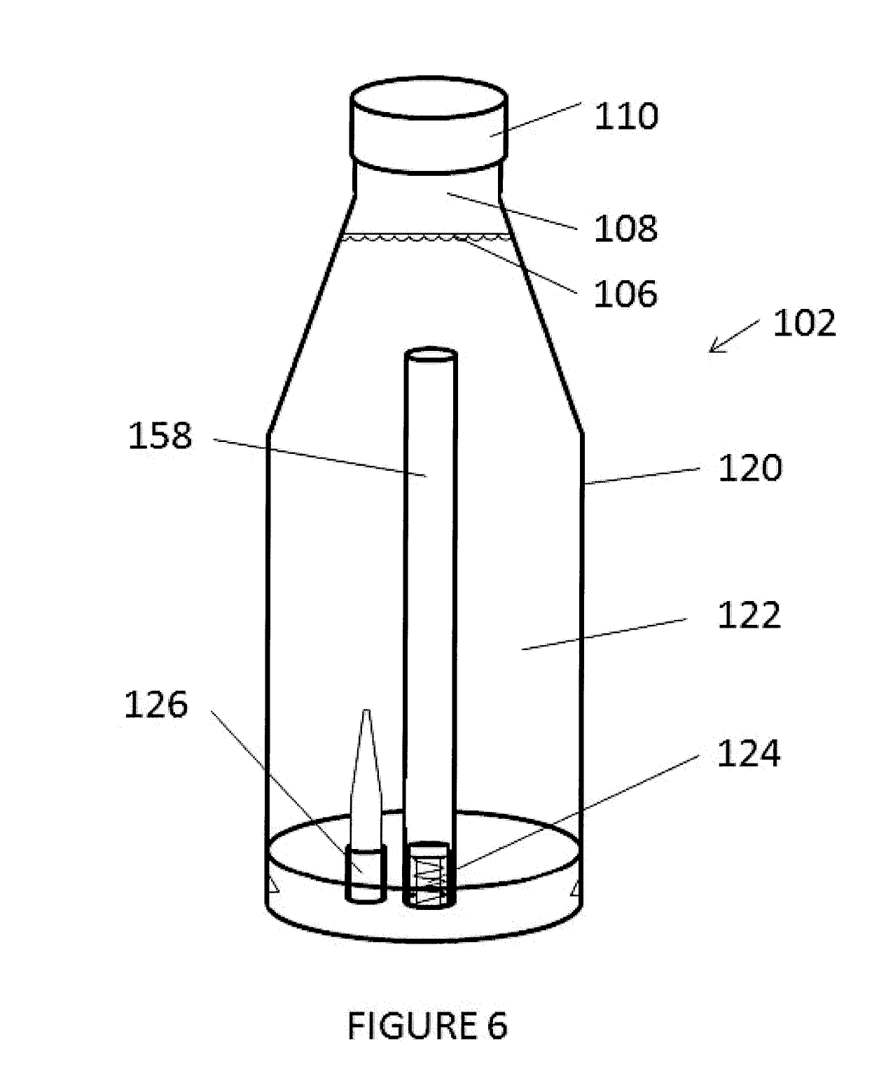

A further embodiment of the invention consists of container 102 for making a carbonated beverage, as discussed above with respect to FIG. 5 and further shown in FIG. 6. Container 102 shown in FIGS. 5 and 6 is removably engageable with a carbonator (such as carbonator 104 shown in FIG. 5).

Referring to FIG. 5, first container outlet valve 124 is fluidly engageable with first carbonator outlet port 128 when first container outlet valve 124 is in the open position. Container inlet valve 126 is fluidly engageable with carbonator inlet port 130 when container inlet valve 126 is in the open position. Container chamber 122 is engageable with at least one pump 150 in fluid communication with carbonation chamber 142 to transfer liquid 106 between container 102 and carbonation chamber 142 and transfer carbon dioxide gas 148 between carbonation chamber 142 and the container chamber 122 when container 102 is engaged with carbonator 104, thereby carbonating liquid 106. When container 102 is disengaged from carbonator 104 (as shown in FIG. 1), first container outlet valve 124 and container inlet valve 126 are closed to fluidly seal container 102 containing carbonated liquid 154. In this manner, the carbonated liquid substantially maintains its carbonation level for later consumption.

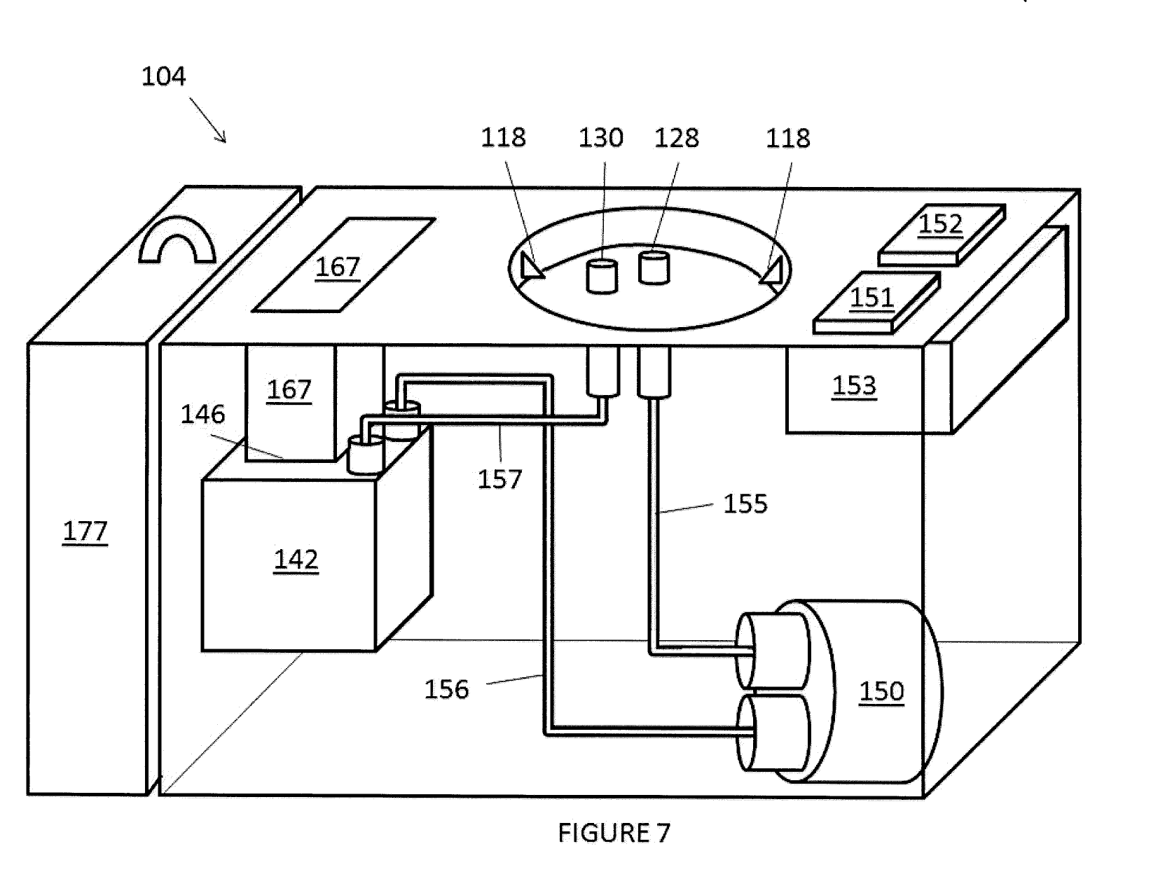

A further embodiment of the invention consists of carbonator 104 for making a carbonated beverage, as discussed above with respect to FIG. 5 and shown in FIG. 7. The carbonator is removably engageable with a container (such as container 102 shown in FIG. 5, for example). Carbonator 104 has at least one pump in fluid communication with carbonation chamber 142 and is fluidly engageable with container chamber 122. Referring to FIG. 5, when container 102 is disengaged from carbonator 104, first container outlet valve 124 and container inlet valve 126 are closed to fluidly seal container 102 containing the carbonated liquid.

Referring to FIG. 5, for liquid 106 to be carbonated, a carbon dioxide source 144 is present in carbonation chamber 142. The structure and process related to providing carbon dioxide source 144 in carbonation chamber 142 will now be discussed in detail.

As shown in FIG. 5, beverage carbonation system 100 may comprise a carbon dioxide cartridge 166 for containing carbon dioxide source 144. As illustrated, carbonator 104 has a cartridge receptacle 167 for receiving at least a portion of carbon dioxide cartridge 166. Optionally, as shown in FIG. 5, carbon dioxide cartridge 166 is inserted into cartridge receptacle 167 so that a portion of carbon dioxide cartridge 166 remains exposed. In this manner, the user can grasp a portion of carbon dioxide cartridge 166 to remove the carbon dioxide cartridge from carbonator 104. Alternatively, carbon dioxide cartridge 166 may be fully inserted into carbonator 104. In this case, carbon dioxide cartridge may be accessible directly or by an opening mechanism (such a hinged or sliding cover, for example, not shown).

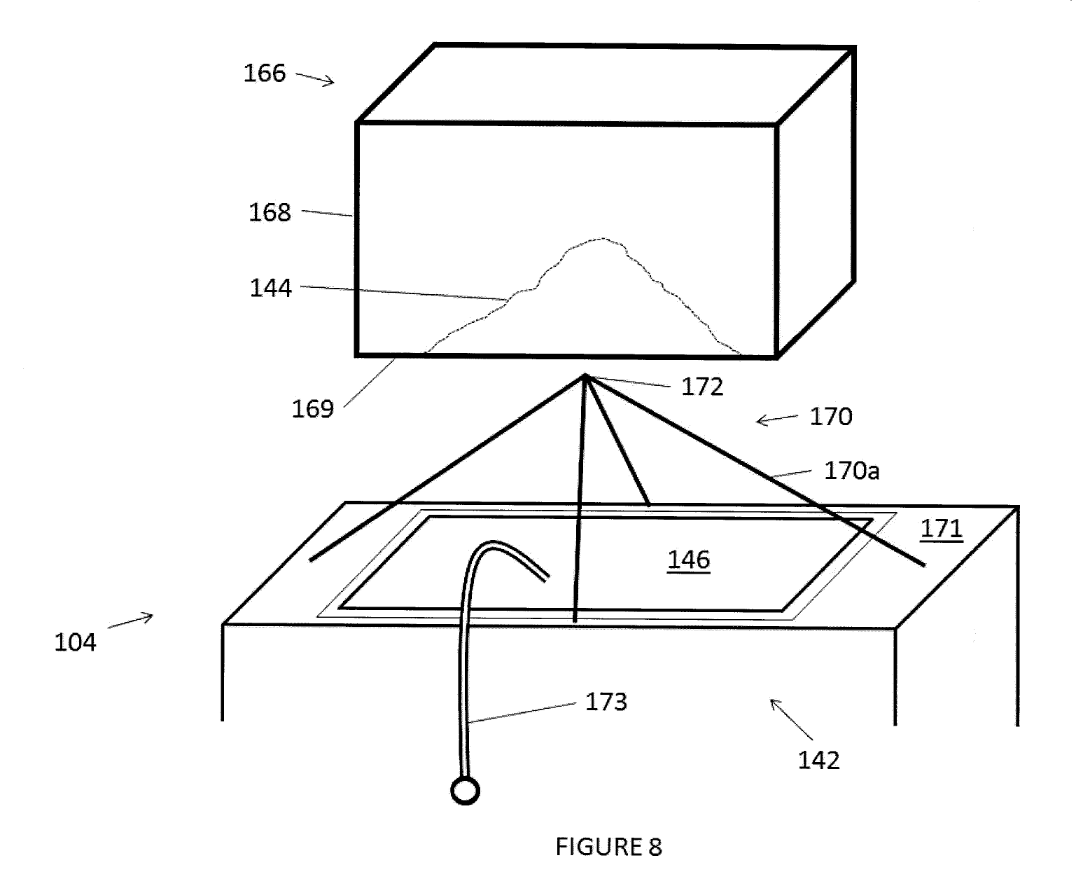

For greater clarity, FIG. 8 shows carbonation chamber 142 and carbon dioxide cartridge 166 in the absence of cartridge receptacle 167. Optionally, carbon dioxide cartridge 166 comprises a hollow housing 168 for storing carbon dioxide source 144 therein. More specifically, hollow housing 168 of carbon dioxide cartridge 166 may seal the carbon dioxide source 144 therein so that the user cannot access the carbon dioxide source prior to its insertion into carbonator 104. Sealing carbon dioxide source 144 inside carbon dioxide cartridge 166 may offer the advantages of maintaining source purity, keeping carbon dioxide source 144 dry until needed and ensuring the right quantity of carbon dioxide source 144 is used in the reaction. Hollow housing 168 may have a pierceable portion 169. Optionally, pierceable portion 169 runs along a bottom surface of hollow housing 168. More specifically, pierceable portion 169 may be made of aluminum foil, while the remainder of hollow housing 186 may be made of plastic.

As described above, with reference to FIG. 5, liquid 106 contacts carbon dioxide source 144 in carbonation chamber 142. In some embodiments, carbonator 104 has transfer mechanism 170 (as exemplified in FIG. 8) for transferring carbon dioxide source 144 from carbon dioxide cartridge 166 to carbonation chamber 142. Carbonation chamber 142 may be integrally formed in carbonator 104. In the example embodiment shown in FIG. 8, transfer mechanism 170 comprises at least one cutter 170a configured to cut away at least a portion of the carbon dioxide cartridge 166 when the carbon dioxide cartridge 166 is inserted into carbonator 104 to release the carbon dioxide source 144 from the carbon dioxide cartridge 166 into carbonation chamber 142.

As shown in FIG. 8, cutter 170a may sit on top surface 171 of carbonation chamber 142. As illustrated, cutter 170a may be a pyramid shaped metal wire that converges at a sharp apex 172. Optionally, cutter 170a is recessed into cartridge receptacle 167 (see FIG. 5, not shown in FIG. 8) to minimize the risk that cutter 170a injures the user's hand when carbon dioxide cartridge 166 is placed into cartridge receptacle 167. Top surface 171 of carbonation chamber 142 has an access hatch 146 that falls downwardly when the user pulls lever 173. Access hatch 146 is illustrated as a hinged door, but it may also be a sliding door, for example

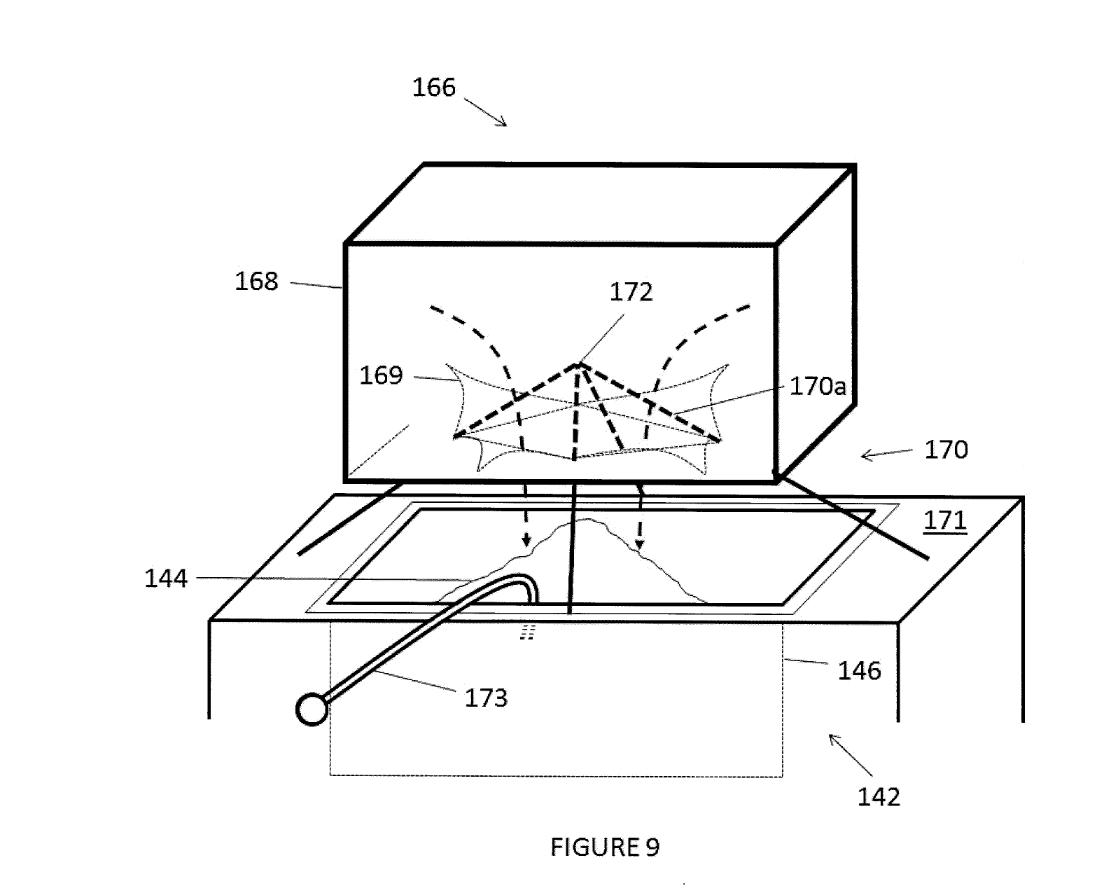

FIG. 8 shows access hatch 146 in the closed position. FIG. 9 shows access hatch 146 in the open position, after the user has pulled lever 173. In the alternative, a depressible button may be used to open access hatch 146. As shown in FIG. 9, when the user advances carbon dioxide cartridge 166 into cartridge receptacle 167 (see FIG. 5, not shown in FIG. 9), pierceable portion 169 comes into contact with apex 172 of cutter 170a, and is pierced or punctured to create an opening in carbon dioxide cartridge 166.

Once cutter 170a creates an opening in hollow housing 168 of carbon dioxide cartridge 166, carbon dioxide source 144 is transferred from carbon dioxide cartridge 166 to carbonation chamber 142. Optionally, carbonation chamber 142 is located below cartridge receptacle 167, and transfer mechanism 170 is configured to create an opening in the bottom of hollow housing 168. In this case, once hollow housing 168 is opened, carbon dioxide source 144 falls from carbon dioxide cartridge 166 into carbonation chamber 142. Alternatively, cartridge receptacle 167 is not necessarily located above carbonation chamber 142. In this case, a negative pressure pump (not shown) may be used to draw the carbon dioxide source 144 from carbon dioxide cartridge 166 into carbonation chamber 142.

Referring to FIG. 9, after carbon dioxide source 144 moves into carbonation chamber 142, the lever may be returned to its original position to close access hatch 146. Once access hatch 146 has closed, the carbonation process may be commenced. In turn, the carbon dioxide source 144 reacts with the liquid in carbonation chamber 142 to form the carbon dioxide gas therein, which then travels to container chamber 122 (see FIG. 5).

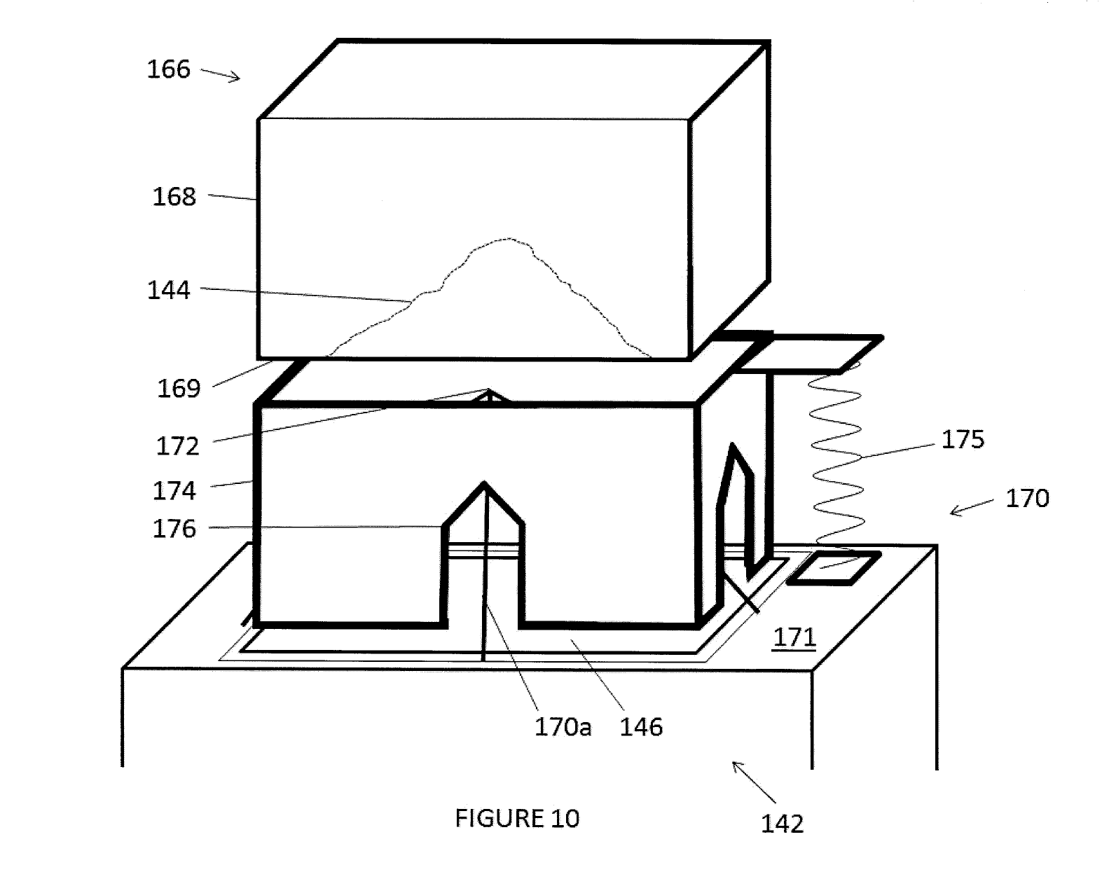

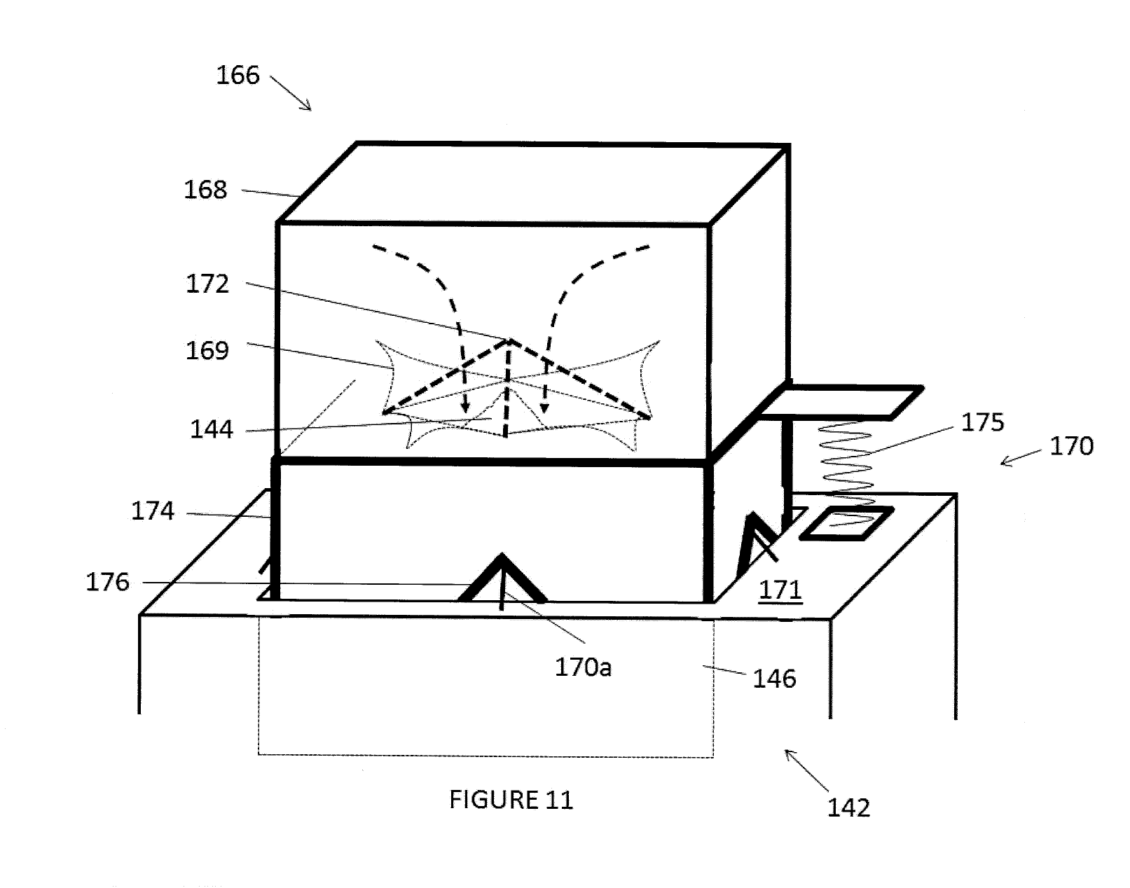

An alternative transfer mechanism 170 is illustrated in FIGS. 10 and 11. FIG. 10 shows access hatch 146 and cutter 170a as discussed above. However, in this embodiment, a moveable shaft 174 is biased away from access hatch 146 by spring 175. Moveable shaft 174 has recesses 176 therein for accommodating cutter 170a. As shown in FIG. 11, when the user places carbon dioxide cartridge 166 into cartridge receptacle 167 (FIG. 5), carbon dioxide cartridge 166 pushes moveable shaft 174 against access hatch 146 to push access hatch 146 into carbonation chamber 142. Once carbonation chamber 142 is open, carbon dioxide source 144 is transferred to carbonation chamber 142 (by gravity or a pressure differential, for example).

When the user removes carbon dioxide cartridge 166 from cartridge receptacle 167, spring 175 biases moveable shaft 174 to its initial position, thereby allowing access hatch 146 to move to a closed position. Alternatively, the process of lifting moveable shaft 174 may be started automatically my opening a latch that otherwise holds moveable shaft 174 down. Optionally, access hatch 146 is spring-loaded (not shown), and thereby biased to the closed position. Once access hatch 146 has closed, the carbonation process may begin.

Although transfer mechanism 170 has been explained as comprising at least one cutter 170a, transfer mechanism 170 may operate without a cutter. As one example, negative pressure may be used to tear away a perforated portion of carbon dioxide cartridge 166, to access carbon dioxide source 144 therein.

When at least a portion of carbon dioxide cartridge 166 is inserted into carbonator 104, carbon dioxide cartridge 166 is optionally removed from carbonator 104 after a single carbonation process has been completed, as discussed above. Optionally, carbon dioxide cartridge 166 is disposable, and may be discarded into the trash or recycled after use.

In an alternative embodiment, carbon dioxide cartridge 166 may be manually openable by the user. It may be similar to a coffee creamer pack, for example, as is known in the art to have a peel-off lid. Referring to FIG. 1, in this case, the user may open the carbon dioxide cartridge 166 outside of the carbonator 104 and pour the carbon dioxide source 144 (shown in FIG. 8) from the cartridge into carbonation chamber 142, without inserting any portion of carbon dioxide cartridge 166 into carbonator 104.

In some embodiments, carbonator 104 has a waste reservoir 177 (see FIG. 1). Some particular liquids and carbon dioxide sources react with one another to produce residual waste products. For example, tap water will react with a mixture of citric acid and sodium bicarbonate to produce some solid residual waste product, such as, for example, sodium citrate. As illustrated in FIG. 1, waste reservoir 177 may be located in carbonator 104 outside carbonation chamber 142. Waste reservoir 177 is at least partially removable from a remaining portion of carbonator 104 (i.e. the portion of carbonator remaining after waste reservoir 177 is removed). Waste reservoir 177 may be a container that is removable from the remainder of carbonator 104, as shown in FIG. 1. In some embodiments, waste reservoir is a sliding tray the user can pull at least partially out of carbonator 104 to access a waste product therein (not shown).

In one embodiment, waste reservoir 177 may be removed from carbonator 104 and rinsed or dumped into the trash, then reinserted into carbonator 104 for reuse. Typically, the user should clean and/or empty waste reservoir 177 after approximately every 5 to 10 carbonation cycles. However, this will vary with the volume of liquid being carbonated per cycle, and the type of liquid and carbon dioxide source used.

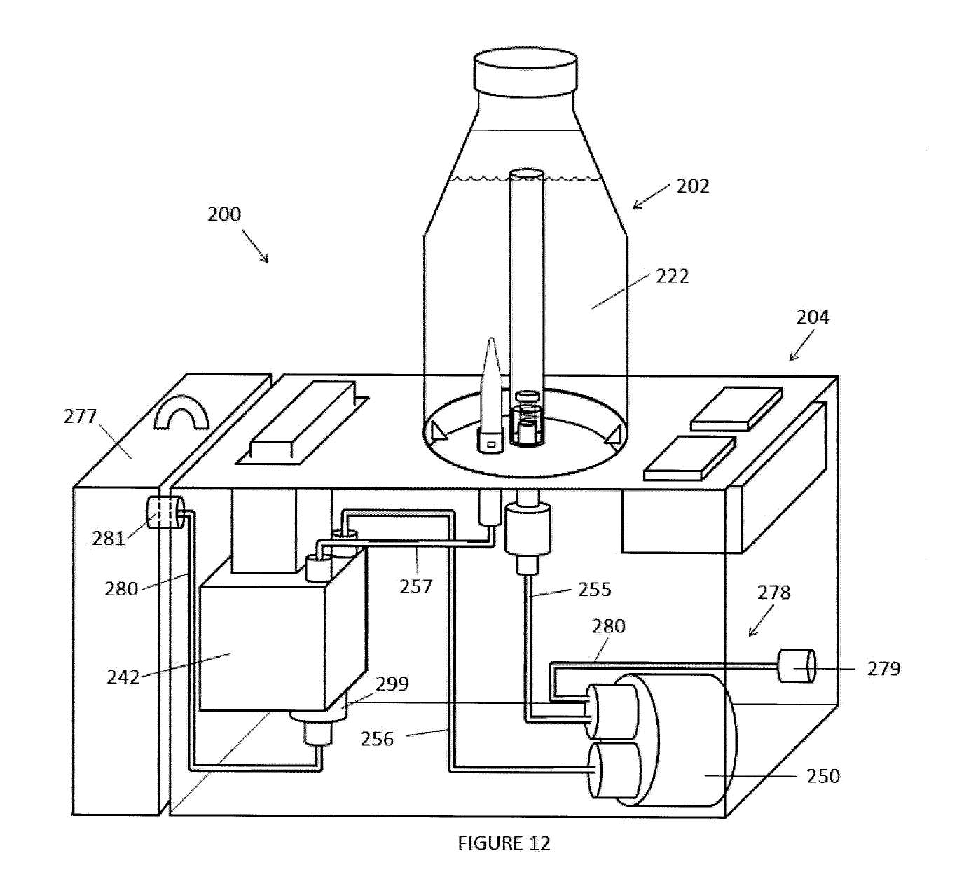

Another exemplary beverage carbonation system is shown in FIG. 12. FIG. 12 illustrates another example beverage carbonation system 200. It will be appreciated that for simplicity and clarity of illustration, elements of beverage carbonation system 200 corresponding or analogous to elements of beverage carbonation system 100 are labeled with the same reference numerals as for beverage carbonation system 100 (plus 100). For brevity, the description of corresponding or analogous elements is not repeated.

Referring to FIG. 12, a waste valve 299 may be located in a wall of carbonation chamber 242 that is openable to release a waste product (not shown) from the carbonation chamber into waste reservoir 277. Waste valve 299 may be a directional control valve. More specifically, waste valve 299 may be an electrically controlled hydraulic directional control valve, such as, for example a solenoid valve. Alternatively, waste valve 299 may be a diaphragm valve or a pinch valve. Optionally, waste reservoir 277 is located below carbonation chamber 242 and waste valve 299 is located in a bottom wall of carbonation chamber 142. In this configuration (not shown), the waste product may be gravity and/or pressure fed into waste reservoir 277. In some embodiments, the waste product may be pumped out of carbonation chamber 242 through a wall that may or may not be a bottom wall of carbonation chamber 242, as will be discussed in more detail below.

In the embodiment shown in FIG. 12, beverage carbonation system 200 has waste evacuation system 278. Waste evacuation system 278 facilitates the removal of waste products from carbonation chamber 242. In some cases, waste evacuation system 278 removes the waste product (not shown) and some pressure from carbonation chamber 242, while substantially maintaining the pressure in container chamber 222.

As shown in FIG. 12, evacuation inlet 279 receives external air from the atmosphere. Pump 250 may draw the external air into evacuation inlet 279. Pump 250 then forces the external air through lines 280 and 256. In turn, the external air passes through carbonation chamber 242, then out of the remainder of carbonator 204 through evacuation outlet 281. In some embodiments external air is pumped through waste evacuation system 278 for approximately 15 seconds. When the external air is forced through carbonation chamber 242, it dislodges residual waste (not shown) from the walls of carbonation chamber 242. Once the residual waste has been dislodged from the inside of the walls of carbonation chamber 242, it may fall (or be pumped) into waste reservoir 277 for removal by the user, as discussed above.

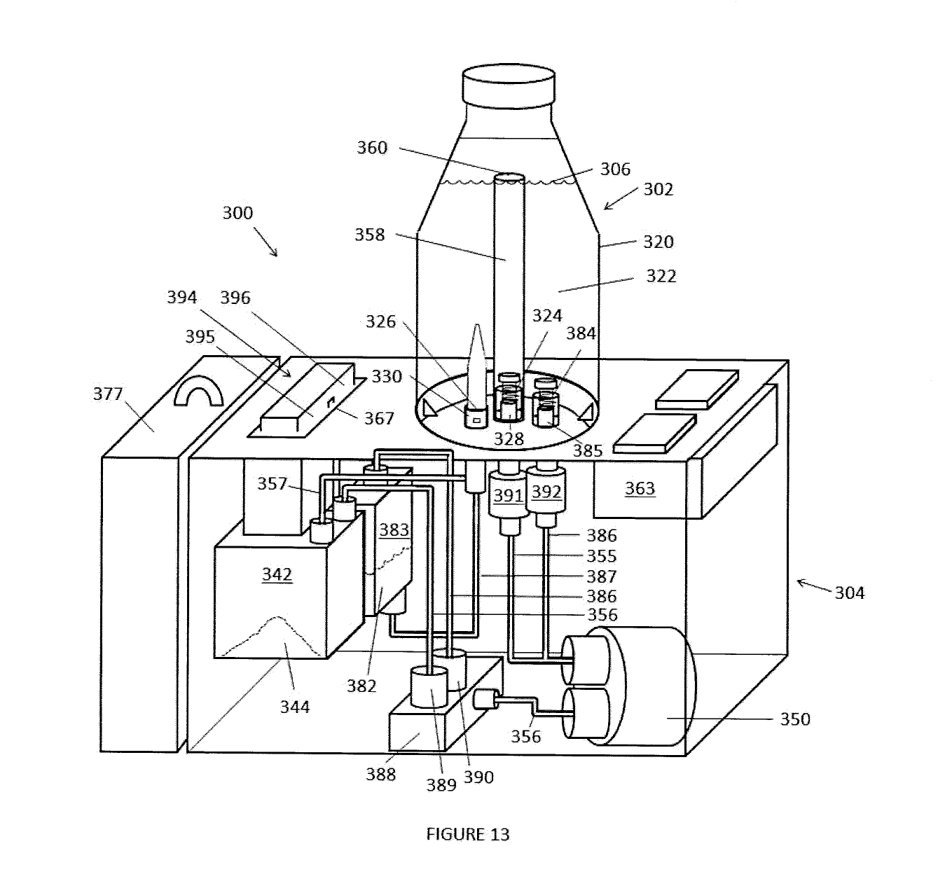

FIG. 13 illustrates another example beverage carbonation system 300. It will be appreciated that for simplicity and clarity of illustration, elements of beverage carbonation system 300 corresponding or analogous to elements of beverage carbonation system 100 are labeled with the same reference numerals as for beverage carbonation system 100 (plus 200). For brevity, the description of corresponding or analogous elements is not repeated.

In this embodiment shown in FIG. 13, beverage carbonation system 300 has a flavor source 382 located in a flavor chamber 383. Flavor chamber 383 may be integrally formed in carbonator 304. Flavor source 382 may be, for example, flavor crystals, coffee grinds, instant coffee, syrup, minerals, concentrated juice, honey or any other beverage additive. Optionally, the flavor source 382 alters the taste of liquid 306. Flavor source 382 is in fluid communication with container chamber 322 to mix with liquid 306 to create flavored beverage in container chamber 322.

Waste evacuation system 278 has been described above with reference to FIG. 12 for removing residual waste (not shown) from carbonation chamber 242. Notably, waste evacuation system 278 may be used in a similar manner to remove a left-over flavor source 382 from flavor chamber 383 (see FIG. 13).

The flavoring process may start before, during or after the carbonation process outlined above. It will be appreciated that if the flavoring process starts before the carbonation process, the liquid 306 that mixes with the flavor source is the original, uncarbonated liquid 306. However, if the flavoring process starts after the carbonation process, the liquid that mixes with the flavor source is at least partially carbonated. In some embodiments, the flavoring cycle takes approximately 15 seconds.

In the embodiment shown in FIG. 13, container 302 has a second container outlet valve 384 in shell 320 having a closed position and an open position. Carbonator 304 has a second carbonator outlet port 385 fluidly engageable with second container outlet valve 384 when second container outlet valve 384 is in the open position. When container 302 is disengaged from carbonator 304, second container outlet valve 384 is closed to fluidly seal container 302 containing the flavored liquid.

Continuing to refer to FIG. 13, second carbonator outlet port 385 and carbonator inlet port 330 are fluidly connected to flavor chamber 383 containing flavor source 382 that produces a flavored liquid. At least one pump 350 is in fluid communication with container chamber 322 and flavor chamber 383 to circulate liquid 306 between container chamber 322 and flavor chamber 383 when container 302 is engaged with carbonator 304, thereby flavoring liquid 306. Liquid 306 flows from container chamber 322 into flavor chamber 383 to interact with flavor source 382 to form a flavored liquid in the flavor chamber 383. Pump 350 pumps liquid 306 along line 386 from second carbonator outlet port 385 to pump 350, then from pump 350 to flavor chamber 383 along line 356 then line 386. Pump 350 then pumps flavored liquid from flavor chamber 383 to carbonator inlet port 330 via line 387.

In some embodiments, pump 350 may pump fluid through the flavor cycle, while another pump (not shown) pumps fluid through the carbonation cycle. Optionally, as shown in FIG. 12, one pump 350 moves fluid through both the carbonation cycle and the flavor cycle. In this case, a manifold 388 having a carbonation solenoid valve 389 and a flavor solenoid valve 390 is used. In this case, a first carbonator valve 391 and a second carbonator valve 392 may also be used.

In one embodiment having only one pump 350, during the carbonation process, first carbonator valve 391 and carbonation solenoid valve 389 are opened. Liquid 306 then flows sequentially through first container outlet valve 324, first carbonator outlet port 328, first carbonator valve 391, line 355, pump 350, line 356, carbonation solenoid valve 389, line 356, carbonation chamber 342, line 357, carbonator inlet port 330, container inlet valve 326 and into container chamber 322.

In this embodiment having only one pump 350, during the flavoring process, second carbonator valve 392 and flavor solenoid valve 390 are opened. Liquid 306 then flows sequentially through second container outlet valve 384, second carbonator outlet port 385, line 386, pump 350, line 356, flavor solenoid valve 390, line 386, flavor chamber 383, line 387, carbonator inlet port 330, container inlet valve 326 and into container chamber 322.

Typically, the carbonation process and flavoring process occur at different times. In this case, when first carbonator valve 391 and carbonation solenoid valve 389 are open to facilitate carbonation, second carbonator valve 392 and flavor solenoid valve 390 are closed to block the flavoring process. Similarly, when second carbonator valve 392 and flavor solenoid valve 390 are open to facilitate flavoring, first carbonator valve 391 and carbonation solenoid valve 389 are closed to block carbonation. Optionally, when the flavoring process is occurring, carbon dioxide gas may be moving passively (without the aid of pump 350) from high pressure carbonation chamber 342 via line 357 to container chamber 322.

First carbonator valve 391 and second carbonator valve 392 may be any suitable types of valves, including, but limited to, directional control valves, diaphragm valves, or pinch valves. Controller 363 may be configured to open and close the carbonator and solenoid valves.

In the embodiment shown in FIG. 13, first container outlet valve 324 and second container outlet valve 384 are shown as two separate outlets. Alternatively, the first container outlet valve 324 and the second container outlet valve 384 may be the same container outlet. In other words, liquid 306 may pass through the same container outlet to be flavored and, at a different point in time, to facilitate carbonation. For example, liquid 306 may pass through first container outlet valve 324 to be flavored, and then pass through first container outlet valve 324 to facilitate carbonation, in the absence of a separate second container outlet valve 384. In this case, if carbonation tube 358 is present, the volume of water above first end 160 of carbonation tube 358 should be sufficient for carbonation and flavoring purposes.

In the embodiment shown in FIG. 13, a single container inlet valve 326 and single carbonator inlet port 330 are present. In this case, the carbon dioxide gas and the flavored liquid enter container chamber 322 via the same container inlet valve 326 and carbonator inlet port 330. Alternatively, a second container inlet valve and a second carbonator inlet port (not shown) may be present so that the carbon dioxide gas and the flavored liquid enter container chamber 322 via different container inlet valve/carbonator inlet port.

For liquid 306 to be flavored, a flavor source 382 is present in flavor chamber 383. The structure and process for providing flavor source 382 into flavor chamber 383 will now be discussed.

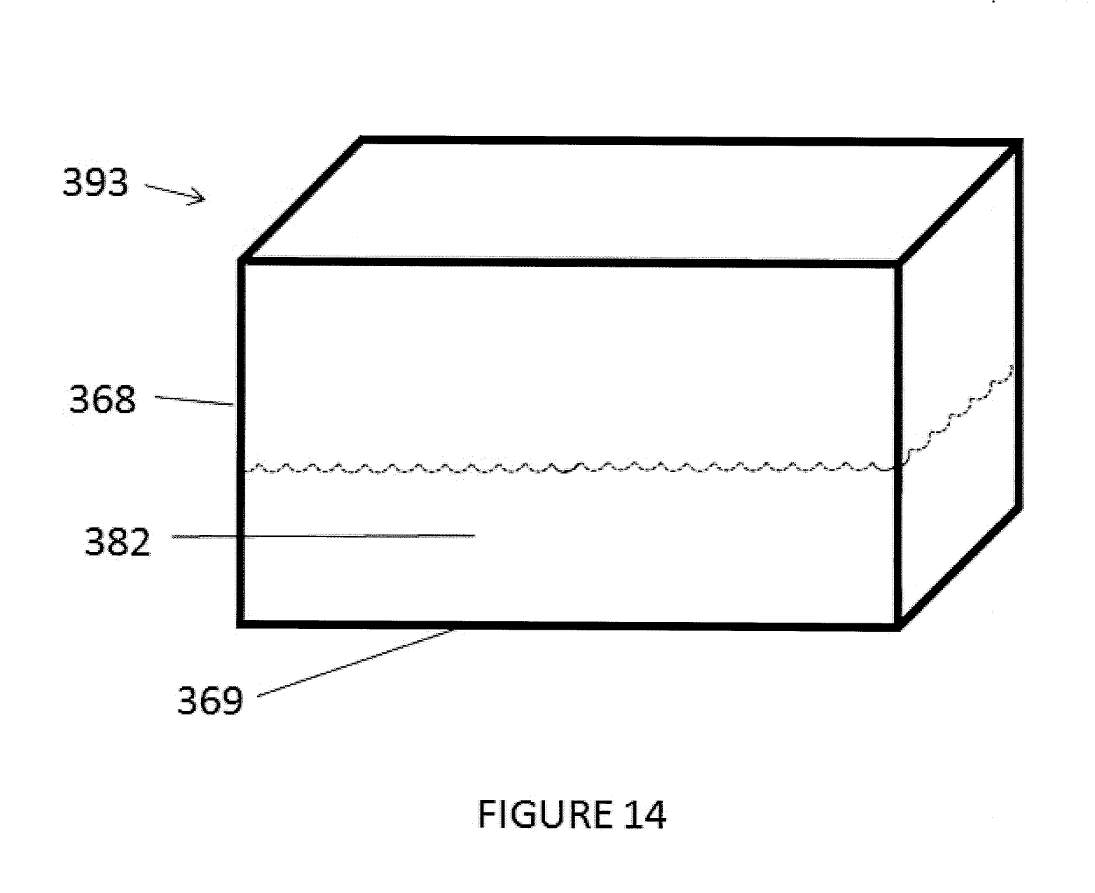

In some embodiments, beverage carbonation system 300 has a flavor cartridge 393 for containing flavor source 382. An example flavor cartridge is shown in FIG. 14. Carbonator 304 may have a cartridge receptacle 367 therein (see FIG. 13) for receiving at least a portion of flavor cartridge 393, shown in FIG. 14. Flavor cartridge 393 may be similar in structure and operation as the carbon dioxide cartridge 166 illustrated in FIG. 8. It will be appreciated that for simplicity and clarity of illustration, elements of carbon dioxide cartridge 166 corresponding or analogous to elements of flavor cartridge 393 are labeled with the same reference numerals as for carbon dioxide cartridge 166 (plus 200). For brevity, the description of corresponding or analogous elements is not repeated.

A transfer mechanism, similar in structure and operation to transfer mechanism 170 outlined above with respect to either of the embodiments shown in FIGS. 8-9 and FIGS. 10-11 may be used to release the flavor source 382 from flavor cartridge 393 (FIG. 14) into flavor chamber 383 (FIG. 13).

In an alternative embodiment, flavor cartridge may be manually openable by the user. It may be similar to a coffee creamer pack, for example, as is known in the art to have a peel-off lid. In this case, the user may open the flavor cartridge 393 (shown in FIG. 14) outside of the carbonator 104 and pour the flavor source 382 from the cartridge into the flavor chamber 383 (shown in FIG. 13), without inserting any portion of flavor cartridge 393 into carbonator 304.

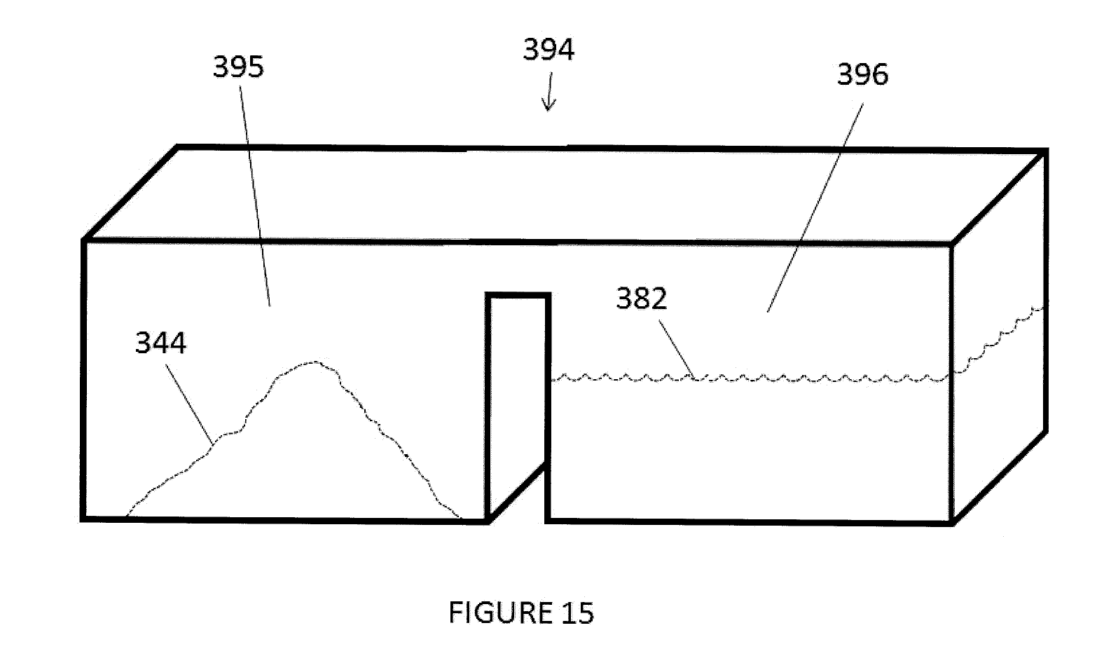

FIG. 15 shows an alternative embodiment for the carbon dioxide and flavor cartridges. FIG. 15 shows a combination cartridge 394 having a carbon dioxide portion 395 for containing carbon dioxide source 344. Combination cartridge 394 also has a flavor portion 396 for containing flavor source 382. The beverage carbonation system may comprise at least one cartridge receptacle 367 (see FIG. 13) for receiving at least a portion of carbon dioxide portion 395 and flavor portion 396.

Referring to FIG. 13, when combination cartridge 394 is present, beverage carbonation system 300 has at least one transfer mechanism (not shown) for transferring flavor source 382 from flavor portion 396 to flavor chamber 383 and carbon dioxide source 344 from carbon dioxide portion 395 to carbonation chamber 342. The at least one transfer mechanism may be similar in structure and operation to transfer mechanism 170 outlined above with respect to either of the embodiments shown in FIGS. 8-9 and FIGS. 10-11. There may be a corresponding transfer mechanism for each of the carbon dioxide portion 395 and flavor portion 396, or a single transfer mechanism for both.

As shown in FIG. 13, carbon dioxide portion 395 and flavor portion 396 may be coupled to one another. In some cases, this coupling allows for simultaneous insertion into at least one cartridge receptacle 367. It may be more convenient for the user to insert one cartridge body into the carbonator, instead of two separate cartridges. Carbon dioxide portion 395 and flavor portion 396 may be formed as one cartridge having a wall or partial gap therebetween. Optionally, combination cartridge 394 is removable from carbonator 304. When the cartridge portions are coupled together, it is easier for the user to remove and dispose of one cartridge body rather than two unconnected cartridges.

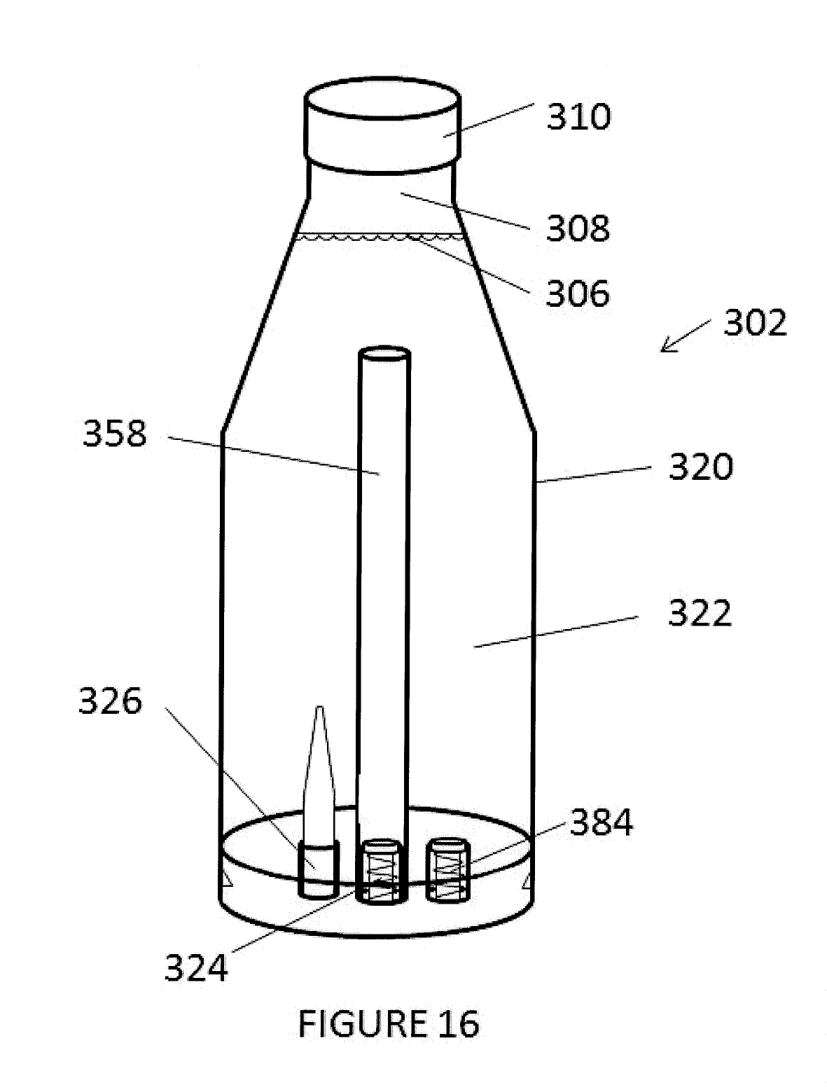

A further embodiment of the invention consists of container 302 for making a carbonated beverage, as illustrated in FIG. 16.

Container 302, as discussed above with respect to FIG. 13 and exemplified in FIG. 16 is removably engageable with a carbonator (such as carbonator 304 shown in FIG. 13, for example). Second container outlet valve 384 is fluidly engageable with second carbonator outlet port 385 of carbonator 304 (FIG. 13) when second container outlet valve 384 is in the open position.

Continuing to refer to FIGS. 13 and 16, container chamber 322 is fluidly engageable with at least one pump 350 in fluid communication with flavor chamber 383 (FIG. 13) to circulate liquid between container chamber 322 and flavor chamber 383 when container 302 is engaged with carbonator 304 (FIG. 13), thereby flavoring the liquid.

When container 302, as shown in FIG. 16, is disengaged from a carbonator (see carbonator 304 in FIG. 13, for example), second container outlet valve 384 is closed to fluidly seal container 302 containing the flavored liquid.

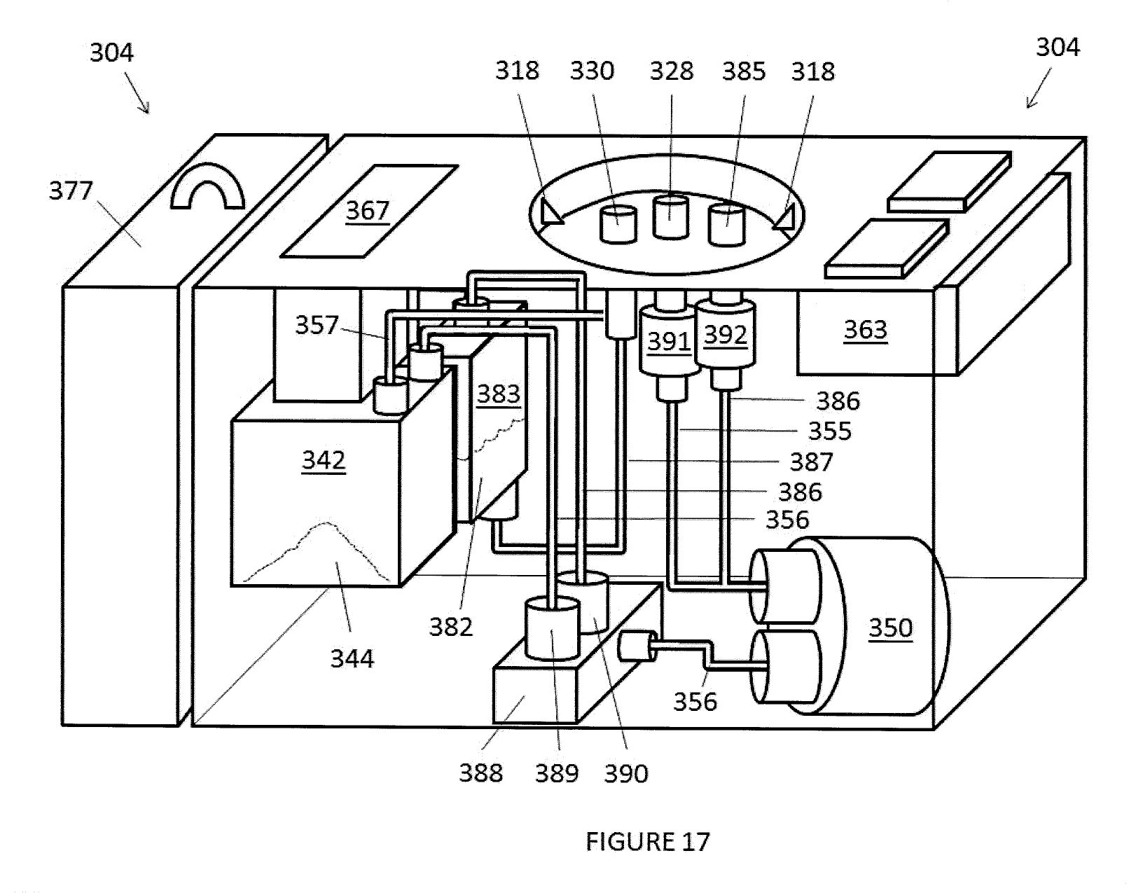

A further embodiment of the invention consists of carbonator 304 for making a carbonated beverage, as discussed above with respect to FIG. 13 and exemplified in FIG. 17. Carbonator 304 has a flavor chamber 383 containing a flavor source 382 that produces a flavored liquid. Second carbonator outlet port 385 is fluidly connected to flavor chamber 383. When container 302 is disengaged from carbonator 304, first second container outlet valve 384, along with first container outlet valve 324 and container inlet valve 384 (FIG. 13), is closed to fluidly seal container 302 containing the flavored liquid.

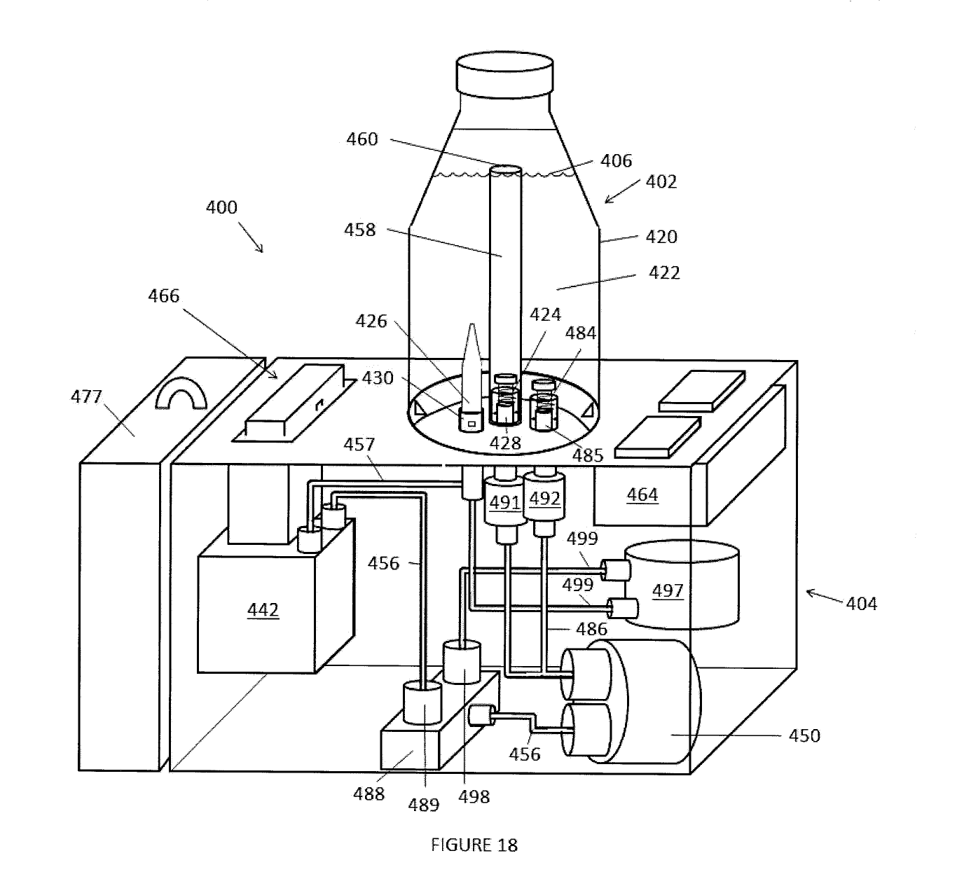

Another example beverage carbonation system 400 is shown in FIG. 18. It will be appreciated that for simplicity and clarity of illustration, elements of beverage carbonation system 400 corresponding or analogous to elements of beverage carbonation system 100 are labeled with the same reference numerals as for beverage carbonation system 100 (plus 300). For brevity, the description of corresponding or analogous elements is not repeated.

In this embodiment shown in FIG. 18, beverage carbonation system 400 has a removable filter (not shown) located in a filter chamber 497. Filter chamber 497 in carbonator 404 contains a removable filter (not shown) in fluid communication with container chamber 422 to filter liquid 406. In some cases, the user needs to replace the removable filter approximately every 50 filtration cycles.

The filtering process may start before or after the carbonation process outlined above. It will be appreciated that if the filtration process starts before the carbonation process, the liquid 406 that mixes with the flavor source is the original, uncarbonated liquid 406. However, if the filtering process starts after the carbonation process, the liquid that passes through the filter is at least partially carbonated. Preferably, liquid 106 is filtered before it is carbonated. Alternatively, the carbonated liquid can be subsequently filtered. However, it is preferred to run the carbonated liquid thorough the filter at an elevated pressure. At lower pressures, the filter may undesirably remove some carbonation from the carbonated liquid. In some embodiments, the filtering process lasts for approximately 20 seconds.

Typically, the filtering process occurs before any flavoring process. Otherwise, the filter may undesirably remove some of the flavor from any flavored liquid.

The filtering process occurs when container 402 is engaged with carbonator 404, as shown in FIG. 18. When second container outlet valve 484 is open and fluidly engages second carbonator outlet port 485, liquid 406 flows from container chamber 422 into filter chamber 497 to pass through a filter (not shown) therein, to form a filtered liquid. The filter may be an active carbon filter, for example. Alternatively, the filter (not shown) in filter chamber 497 may be a reverse osmosis filter, an ultra-violet filter, or a membrane filter, for example.

When container 402 and carbonator 404 are engaged with one another, container inlet valve 426 is fluidly coupled to carbonator inlet port 430 to receive the filtered liquid from filter chamber 497.

At least one pump 450 circulates liquid 406. Pump 450 may pump liquid 406 sequentially through second container outlet valve 484, second carbonator outlet port 485, second carbonator valve 492, line 486, pump 450, line 456, filter solenoid valve 498, line 499, filter chamber 497, line 499, carbonator inlet port 430, container inlet valve 426 and into container chamber 422.

In some embodiments, pump 450 may pump fluid through the filter cycle, while another pump (not shown) pumps fluid through the carbonation cycle. Optionally, as shown in FIG. 15, one pump 450 pumps fluid through both the carbonation cycle and the filter cycle. In this case, a manifold 488 is used.

Typically, the carbonation process and filtration process occur at different times. In this case, when first carbonator valve 491 and carbonation solenoid valve 389 are open to facilitate carbonation, second carbonator valve 492 and filter solenoid valve 498 are closed to block the filtering process. Similarly, when second carbonator valve 492 and filter solenoid valve 498 are open to facilitate flavoring, first carbonator valve 491 and carbonation solenoid valve 489 are closed to block carbonation. While the filtering is occurring, carbon dioxide gas may be passively moving (i.e. without the aid of pump 450) from high pressure chamber 442 via line 457 to container chamber 422.

Filter solenoid valve 498 may be any suitable type of valve, including, but limited to, a directional control valve, diaphragm valve, or pinch valve. Controller 463 may be configured to open and close filter solenoid valve 498.

In the embodiment shown in FIG. 18, first container outlet valve 424 and second container outlet valve 484 are shown as two separate outlets. Alternatively, the first container outlet valve 424 and the second container outlet valve 484 may be the same container outlet. In other words, liquid 406 may pass through the same container outlet to be filtered and, at a different point in time, to facilitate carbonation. For example, liquid 406 may pass through first container outlet valve 424 to be filtered, then pass through first container outlet valve 424 to be carbonated, in the absence of a separate second container outlet valve 484. In this case, if carbonation tube 458 is present, the volume of water above first end 460 of carbonation tube 458 should be sufficient for filtering and carbonation.

In the embodiment shown in FIG. 18, a single container inlet valve 426 and single carbonator inlet port 430 are present. In this case, the carbon dioxide gas and the filtered liquid enter container chamber 422 via the same container inlet valve 426 and carbonator inlet port 430. Alternatively, a second container inlet valve and a second carbonator inlet port (not shown) may be present so that the carbon dioxide gas and the filtered liquid enter container chamber 422 via different container inlet valve/carbonator inlet ports.

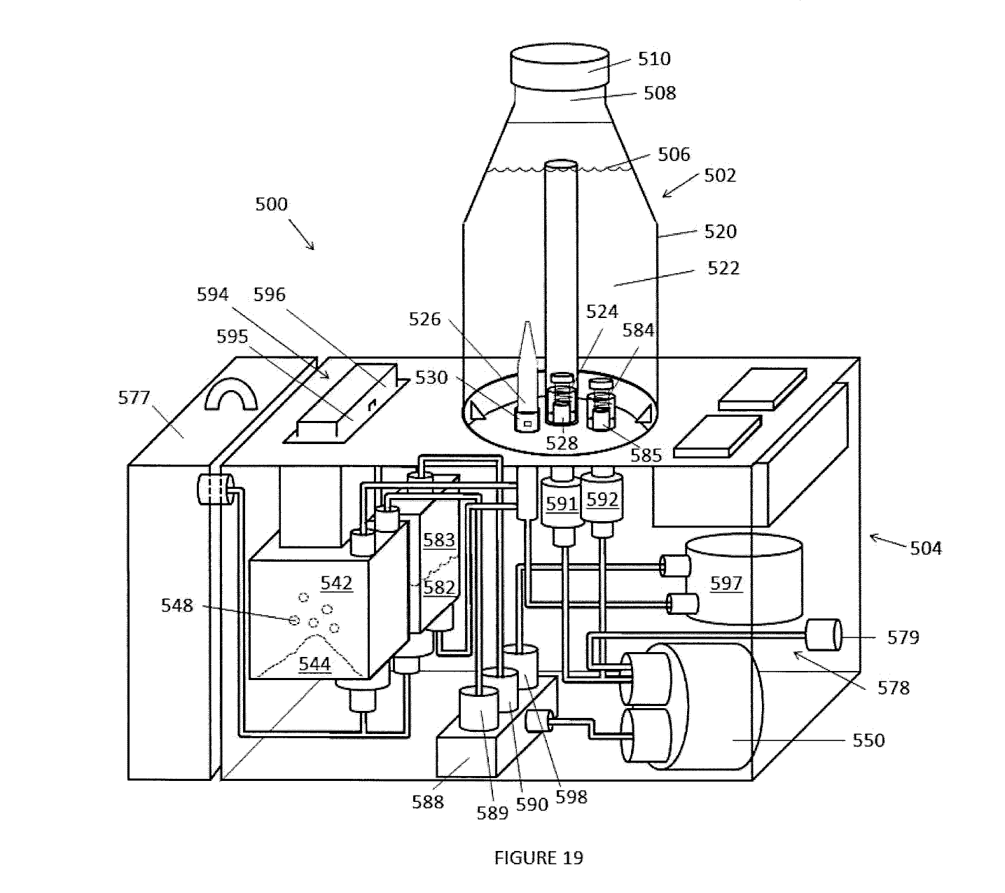

In a further embodiment, beverage carbonation system 500, as shown in FIG. 19, includes all of the features shown in FIGS. 5, 12, 13 and 18. FIG. 19 illustrates the respective features associated with carbonation, waste evacuation, flavoring and filtration. It will be appreciated that for simplicity and clarity of illustration, elements of beverage carbonation system 500 corresponding or analogous to elements of beverage carbonation systems 100, 200, 300 and 400 are labeled with the same reference numerals as for beverage carbonation systems 100, 200, 300 and 400 (but in the 500's). For brevity, the description of corresponding or analogous elements is not repeated.

In the embodiment shown in FIG. 19, beverage carbonation system 500 comprises carbonation chamber 542, evacuation system 578, flavor chamber 583 and filter chamber 597, each of which function as outlined above.

A further embodiment comprises a method of making a carbonated beverage. With reference to FIG. 19, the method comprises introducing liquid 506 into container 502. Container 502 is then sealed with closure 510. Container 502 is engaged with carbonator 504. A carbon dioxide source 544 is placed in carbonation chamber 542. This may be done by emptying the contents of the carbon dioxide portion 595 of combined cartridge 594 into carbonation chamber 542. This may be done before or after container 502 is engaged with carbonator 504. A first container outlet valve 524 in container 502 is opened to transfer a portion of liquid 506 to carbonation chamber 542 to react with carbon dioxide source 544 in carbonation chamber 542 to produce carbon dioxide gas 548. A container inlet valve 526 in container 502 is opened to transfer carbon dioxide gas 548 produced by carbon dioxide source 544 into container 502 to obtain a carbonated liquid in container 502. First container outlet valve 524 and container inlet valve 526 are then closed to seal container 502. Container 502 is then disengaged from carbonator 104. In some cases, this process takes approximately 40 seconds.

Continuing to refer to FIG. 19, the following steps may occur prior to closing first container outlet valve 526 and container inlet valve 526 to seal container 502 and prior to disengaging container 502 from carbonator 504. A flavor source 582 may be placed in flavor chamber 583. This may be done before, after, or at the same time that carbon dioxide source 544 is placed in carbonation chamber 542. A second container outlet valve 584 is opened in container 502 to transfer a portion of liquid 506 to flavor chamber 583 to mix liquid 506 with flavor source 582 to produce a flavored liquid in flavor chamber 583. Container inlet valve 526 in container 502 is opened to transfer flavored liquid produced by flavor source 582 into container 502 to obtain a flavored liquid in container 502. Container inlet valve 526 may be opened before, during, or after liquid 506 initially mixes with flavor source 582. In some cases, the flavoring process takes approximately 15 seconds.

In some cases, liquid 506 is filtered by passing the liquid through a filter (not shown) located in carbonator 504 within filter chamber 597, to obtain a filtered beverage in container 502. In some cases, the filtration process takes approximately 20 seconds.

In some cases, external air is introduced into an evacuation system 578 to facilitate the removal of residual waste (not shown) and pressure from carbonation chamber 542. External air is introduced into carbonator 504 via evacuation inlet 579, passes through carbonation chamber 542 to dislodge residual waste therein, and then exits carbonator 504. In some cases, the external air is also introduced to the evacuation system to facilitate the removal of residual waste (not shown) and pressure from the flavor chamber 583 using the same process. In some cases, the external air cycles for approximately 15 seconds.

Continuing to refer to FIG. 19, an example method of producing a filtered, carbonated and flavored beverage is described below. In this case, liquid 506 is first filtered through filter chamber 597 and back to container chamber 522. After the filtering cycle completes, the carbonation cycle begins. As part of the carbonation cycle, liquid 506 is introduced to carbonation chamber 542 to react with carbon dioxide source 544 therein. After liquid 506 has been introduced to carbonation chamber 542, liquid 506 passes through flavor chamber 583 and back to container chamber 522 to produce a flavored beverage therein. During the flavoring cycle, carbon dioxide gas 548 passively moves from the higher pressure carbonation chamber 542 to the lower pressure container chamber 522, to inject the carbon dioxide gas 548 into container chamber 522. After the flavoring process has completed, carbon dioxide gas in headspace 163 of container chamber 522 is pumped through carbonation chamber 542 and back into container chamber 522. Alternatively, the entire carbonation cycle may be completed prior to the flavoring cycle (i.e. the process of carbon dioxide gas in headspace 163 of container chamber 522 passing through carbonation chamber 542 and back into container chamber 522 may also start and finish before the flavoring begins). After the cycling of the carbon dioxide gas and flavoring have been completed, waste evacuation system 578 is activated to remove a waste product from at least one of carbonation chamber 542 and flavor chamber 543. The entire process as described above, including container 102 and carbonator 104 engagement and disengagement, may take approximately 1½ minutes to 2½ minutes, depending on the volume of the liquid to be treated. In alternative embodiments, the example method of producing a filtered, carbonated and flavored beverage outlined above may be completed in the absence of at least one of the filtering cycle, the flavoring cycle and the waste evacuation cycle.

The present invention has been described here by way of example only. Various modification and variations may be made to these exemplary embodiments without departing from the spirit and scope of the invention, which is limited only by the appended claims.

We claim:

1. A beverage carbonation system, comprising:
a container, the container comprising:
a shell defining a container chamber for holding a liquid;
a first container outlet valve in the shell having a closed position and an open position; and
a container inlet valve in the shell having a closed position and an open position; and
a carbonator removably engageable with the container, the carbonator comprising:
a first carbonator outlet port fluidly engageable with the first container outlet valve when the first container outlet valve is in the open position, wherein the first carbonator outlet port is fluidly connected to a carbonation chamber containing a carbon dioxide source that produces a carbon dioxide gas;
a carbonator inlet port fluidly engageable with the container inlet valve when the container inlet valve is in the open position, wherein the carbonator inlet port is fluidly connected to the carbonation chamber; and
at least one pump in fluid communication with the container chamber and the carbonation chamber to transfer the liquid between the container chamber and the carbonation chamber and transfer the carbon dioxide gas between the carbonation chamber and the container chamber when the container is engaged with the carbonator, thereby carbonating the liquid, wherein
when the container is disengaged from the carbonator, the first container outlet valve and the container inlet valve are closed to fluidly seal the container containing the carbonated liquid.

2. The beverage carbonation system of claim 1, wherein
the container further comprises a mouth defined by the shell for receiving the liquid into the container chamber.

3. The beverage carbonation system of claim 2, wherein
the container further comprises a closure for sealing the mouth.

4. The beverage carbonation system of claim 1, wherein
an elevated pressure occurs in the container chamber when the carbonated liquid is formed therein, and
the elevated pressure is substantially maintained during disengagement of the container and the carbonator.

5. The beverage carbonation system of claim 1, wherein
the carbon dioxide source is a solid material that is chemically reactive with the liquid to emit the carbon dioxide gas when the liquid contacts the carbon dioxide source.

6. The beverage carbonation system of claim 5, wherein
the solid material is a mixture of sodium bicarbonate and citric acid, and
the liquid is water.

7. The beverage carbonation system of claim 5, further comprising
a waste reservoir located in the carbonator outside the carbonation chamber and at least partially removable from a remaining portion of the carbonator; and
a waste valve in a wall of the carbonation chamber that is openable to release a waste product from the carbonation chamber into the waste reservoir.

8. The beverage carbonation system of claim 1, further comprising
a carbonation tube fluidly connected to the first container outlet valve and extending inwardly into the container chamber, wherein the carbonation tube is configured to receive carbon dioxide gas from the container chamber for recirculation between the first container outlet valve and the container inlet valve.

9. The beverage carbonation system of claim 1, further comprising
a carbon dioxide cartridge for containing the carbon dioxide source; and
a transfer mechanism for transferring the carbon dioxide source from the carbon dioxide cartridge to the carbonation chamber.

10. The beverage carbonation system of claim 9, wherein
the carbonation chamber is integrally formed in the carbonator, and
the transfer mechanism comprises at least one cutter configured to cut away at least a portion of the carbon dioxide cartridge to release the carbon dioxide source from the carbon dioxide cartridge into the carbonation chamber.

11. The beverage carbonation system of claim 1, further comprising
a second container outlet valve in the shell having a closed position and an open position; and
a second carbonator outlet port fluidly engageable with the second container outlet valve when the second container outlet valve is in the open position, wherein
the second carbonator outlet port is fluidly connected to a flavor chamber containing a flavor source that produces a flavored liquid,
the carbonator inlet port is fluidly connected to the flavor chamber,
the at least one pump is in fluid communication with the container chamber and the flavor chamber to circulate the liquid between the container chamber and the flavor chamber when the container is engaged with the carbonator, thereby flavoring the liquid, and
when the container is disengaged from the carbonator, the second container outlet valve is closed to fluidly seal the container containing the flavored liquid.

12. The beverage carbonation system of claim 11, further comprising
a flavor cartridge for containing the flavor source; and
a transfer mechanism for transferring the flavor source from the flavor cartridge to the flavor chamber.

13. The beverage carbonation system of claim 11, further comprising
a combination cartridge having a carbon dioxide portion for containing the carbon dioxide source and a flavor portion for containing the flavor source; and
at least one transfer mechanism for transferring the flavor source from the flavor portion to the flavor chamber and the carbon dioxide source from the carbon dioxide portion to the carbonation chamber, wherein
the carbon dioxide portion and the flavor portion are coupled to one another.

14. The beverage carbonation system of claim 1, further comprising
a filter chamber in the carbonator and containing a removable filter in fluid communication with the container chamber to filter the liquid.

15. A container for making a carbonated beverage, the container being removably engageable with a carbonator having a first carbonator outlet port fluidly connected to a carbonation chamber containing a carbon dioxide source and having a carbonator inlet port fluidly connected to the carbonation chamber, the container comprising:
a shell defining a container chamber for holding a liquid;
a first container outlet valve in the shell having a closed position and an open position; and
a container inlet valve in the shell having a closed position and an open position, wherein
the first container outlet valve is fluidly engageable with the first carbonator outlet port when the first container outlet valve is in the open position,
the container inlet valve is fluidly engageable with the carbonator inlet port when the container inlet valve is in the open position,
the container chamber is fluidly engageable with at least one pump in fluid communication with the carbonation chamber to transfer the liquid between the container and the carbonation chamber and transfer the carbon dioxide gas between the carbonation chamber and the container chamber when the container is engaged with the carbonator, thereby carbonating the liquid, and
when the container is disengaged from the carbonator, the first container outlet valve and the container inlet valve are closed to fluidly seal the container containing the carbonated liquid.

16. The container of claim 15, further comprising
a second container outlet valve in the shell having a closed position and an open position, wherein
the second container outlet valve is fluidly engageable with a second carbonator outlet port of the carbonator when the second container outlet valve is in the open position,
the second carbonator outlet port is in fluid communication with a flavor chamber of the carbonator,
the carbonator inlet port is in fluid communication with the flavor chamber,
the container chamber is fluidly engageable with the at least one pump in fluid communication with the flavor chamber to circulate the liquid between the container chamber and the flavor chamber when the container is engaged with the carbonator, thereby flavoring the liquid, and
when the container is disengaged from the carbonator, the second container outlet valve is closed to fluidly seal the container containing the flavored liquid.

17. A carbonator for making a carbonated beverage, the carbonator being removably engageable with a container having a first container outlet valve having a closed position and an open position and a container inlet valve having a closed position and an open position, the carbonator comprising:
a first carbonator outlet port fluidly engageable with the first container outlet valve when the first container outlet valve is in the open position, wherein the first carbonator outlet port is fluidly connected to a carbonation chamber containing a carbon dioxide gas;
a carbonator inlet port fluidly engageable with the container inlet valve when the container inlet valve is in the open position, wherein the carbonator inlet port is fluidly connected to the carbonation chamber; and
at least one pump in fluid communication with the carbonation chamber and fluidly engageable with the container chamber to transfer the liquid between the container chamber and the carbonation chamber and transfer the carbon dioxide gas between the carbonation chamber and the container chamber when the carbonator is engaged with the container, thereby carbonating the liquid, wherein
when the container is disengaged from the carbonator, the first container outlet valve and the container inlet valve are closed to fluidly seal the container containing the carbonated liquid.

18. The carbonator of claim 17, further comprising
a flavor chamber containing a flavor source that produces a flavored liquid;
a second carbonator outlet port fluidly engageable with a second container outlet valve in the container when the second container outlet valve is in the open position, wherein
the second carbonator outlet port is fluidly connected to the flavor chamber,
the carbonator inlet port is fluidly connected to the flavor chamber,
the at least one pump is in fluid communication with the flavor chamber to circulate the liquid between the container chamber and the flavor chamber when the container is engaged with the carbonator, thereby flavoring the liquid, and
when the container is disengaged from the carbonator, the second container outlet valve is closed to fluidly seal the container containing the flavored liquid.

19. A method of making a carbonated beverage, comprising:
introducing a liquid into a container;
sealing the container with a closure;
engaging the container with a carbonator;
placing a carbon dioxide source in a carbonation chamber of the carbonator;
opening a first container outlet valve in the container to transfer a portion of the liquid to the carbonation chamber to react with the carbon dioxide source in the carbonation chamber to produce a carbon dioxide gas;
opening a container inlet valve in the container to transfer the carbon dioxide gas produced by the carbon dioxide source into the container to obtain a carbonated liquid in the container;
closing the first container outlet valve and the container inlet valve to seal the container; and
disengaging the container from the carbonator.

20. The method of claim 19, further comprising:
prior to closing the first container outlet valve and the container inlet valve to seal the container and disengaging the container from the carbonator
placing a flavor source in a flavor chamber of the carbonator;
opening a second container outlet valve in the container to transfer a portion of the liquid to the flavor chamber to mix the liquid with the flavor source to produce a flavored liquid in the flavor chamber; and
opening the container inlet valve in the container to transfer the flavored liquid produced by the flavor source into the container to obtain the flavored liquid in the container.
